(19) United States
(12) Patent Application Publication
(10) Pub. No.: US 2022/0291386 A1
(43) Pub. Date: Sep. 15, 2022

(54) LIDAR WITH 4D OBJECT CLASSIFICATION, SOLID STATE OPTICAL SCANNING ARRAYS, AND EFFECTIVE PIXEL DESIGNS

(71) Applicant: NeoPhotonics Corporation, San Jose, CA (US)

(72) Inventors: Ergun Canoglu, Cupertino, CA (US); David J. Dougherty, Pleasanton, CA (US); Jian Wang, San Jose, CA (US); Nizar S. Kheraj, San Ramon, CA (US); Kenneth A. McGreer, Livermore, CA (US)

(21) Appl. No.: 17/691,189

(22) Filed: Mar. 10, 2022

Related U.S. Application Data
(60) Provisional application No. 63/159,252, filed on Mar. 10, 2021.

(51) Int. Cl. G01S 17/89; G01S 7/4863; G01S 7/484

(52) U.S. Cl. CPC G01S 17/89; G01S 7/4863; G01S 7/484

(57) ABSTRACT

Devices are provided to perform imaging using laser light based on scanning without any mechanically moving parts to obtain a scan over the field of view. An optical chip comprises a row of selectable emitting elements comprising: a row feed optical waveguide, a plurality of selectable, electrically actuated solid state optical switches, a pixel optical waveguide associated with each optical switch configured to receive the switched optical signal, and a solid state first vertical coupler associated with the pixel waveguide configured to direct the optical signal out of the plane of the optical chip. The optical chip can be connected with an electrical circuit board to control operation of the optical chip. A lens can be positioned to direct the light from a selected pixel along a specific direction such that a scan over an array of pixels covers a desired portion of the field of view.

### CROSS REFERENCE TO RELATED APPLICATIONS

This application claims priority to copending U.S. provisional patent application 63/159,252 filed Mar. 10, 2021 to Canoglu et al., entitled “Method of Improved Object Classification Based on 4D Point Cloud Data from Lidar and Photonic Integrated Circuit Implementation for Generating 4D Point Cloud Data,” incorporated herein by reference.

### FIELD OF THE INVENTION

This invention relates to efficient optical switches providing laser imaging of a field of view with scanning of the view provided without any mechanical movement through scanning through optical switching across an array of pixels that direct and receive light from a particular angle to an optical chip holding the array of pixels. The invention further relates to the components that provide this functionality and methods of implementing the no-movement imaging using coherent, frequency modulated continuous wave lasers and corresponding detection to obtain position and velocity information.

### BACKGROUND

The ability to analyze and understand the 3D environment (3D Perception) is key to the success of robotic applications such as autonomous vehicles, UAVs, industrial robots, and the like. In mobile environments, 3D perception requires accurate and reliable object classification and tracking to understand current locations of objects as well as to predict their next possible move. See, Cho et al., “A Multi-Sensor Fusion System for Moving Object Detection and Tracking in Urban Driving Environments,” in 2014 IEEE International Conference on Robotics & Automation (ICRA), Hong Kong, China, May 31-Jun. 7, 2014. In applications such as autonomous driving car/UAVs, system may be required to identify and track many objects in real time. Thus, the ability to separate dynamic objects from the static ones can enable prioritization of processing tasks to identify and focus on regions of interest (ROI) leading to a faster response time. Light Detection and Ranging (LIDAR) is becoming a significant tool in the imaging context. See, published U.S. patent application 2016/0274589 to Templeton et al., “Wide-View LIDAR With Areas of Special Attention,” incorporated herein by reference.

### SUMMARY OF THE INVENTION

One of the objectives of present disclosure is to introduce a method in which fast moving objects and their trajectories can be marked as region of interest (ROI) using a single LIDAR image frame. This ROI information then can be processed by machine vision algorithms for more accurate object classification and tracking. Unlike current methods of dynamic ROI identification, the methods described in the present application do not require use of large number of image frames to identify ROI of fast moving objects and their trajectory; depending on the relative speed of objects in the FOV, single image frame may be sufficient to identify ROIs corresponding to objects, their speed and trajectory. Multiframe approaches are described in Rogan, “Lidar Based Classification of Object Movement,” U.S. Pat. No. 9,110,163 B2, 18 Aug. 2015, Vallespi-Gonzales, “Object Detection for and Autonomous Vehicle,” U.S. Pat. No. 9,672,446B1, 6 Jun. 2017 and Rogan, “LIDAR-Based Classification of Object Movement,” Patent application US2016/0162742, all three of which are incorporated herein by reference.

Another objective of the present disclosure is to describe an integrated circuit that enables above mentioned ROI processing by taking advantage of coherent Lidar architecture implemented on photonic integrated circuit. Lidar IC described in this document enables 2D beam steering based on focal plane array vertical emitters with simple ON-OFF controls thus avoiding the complex analog controls of optical phase array based beam steering, including the issue of suppressing side lobes of the mean beam and having large far field beam size.

In a first aspect, the invention pertains to an optical chip comprising, a row of selectable emitting elements. The row of selectable emitting elements comprises a row feed optical waveguide, a plurality of selectable, electrically actuated solid state optical switches, a pixel optical waveguide associated with each optical switch configured to receive the switched optical signal, and a solid state first vertical coupler associated with the pixel waveguide. The solid state first vertical coupler is configured to direct the optical signal out of the plane of the optical chip. In some embodiments, the optical chip can comprise one or more additional plurality of rows of selectable emitting elements each comprising a row feed optical waveguide, plurality of selectable, electrically actuated-solid state optical switches associated with the row feed optical waveguide, a pixel optical waveguide associated with each optical switch, and a mechanically fixed, solid state vertical turning mirror associated with the target waveguide. For the additional plurality of rows of selectable emitting elements, the pixel optical waveguide can be configured to receive the switched optical signal, and the vertical tuning mirror can be configured to direct the optical signal out of the plane of the optical chip. In some embodiments, the optical chip can comprise a feed optical waveguide, a plurality of row switches to direct an optical signal along a row feed optical waveguide. In some embodiments, the optical chip can comprise multiple ports wherein each port is configured to provide input into a row.

In some embodiments, each pixel can comprise a balanced detector that is configured to receive light from the first vertical coupler. In some embodiments each pixel can comprise a solid state second vertical coupler and a balanced detector that is configured to receive light from the second vertical coupler. In some embodiments, each pixel can comprise an optical tap connected to the pixel optical waveguide and to a directional coupler. The directional coupler can be further connected to a receiver waveguide optically coupled to an optical splitter/coupler optically coupled to the first vertical coupler or optically coupler to the second vertical coupler. The balanced detector can comprise two optical detectors respectively optically connected to two output waveguides from the directional coupler.

In some embodiments, the chip can comprise a balanced detector and a directional coupler. The directional coupler can be configured to receive light from a second vertical coupler and from the row input waveguide. The balanced detector can comprise two photodetectors configured to receive output from respective arms of the directional coupler. The balanced detector can be within a receiver pixel separate from a selectable optical pixel.

In some embodiments, the selectable optical pixel further can comprise an optical tap connected to the pixel waveguide, and a monitoring photodetector configured to receive light from the optical tap. In some embodiments, the selectable optical switch can comprise a ring coupler with thermo-optical heaters. In some embodiments, the first vertical coupler can comprise a vertical coupler array. In some embodiments, the first vertical coupler can comprise a groove with a turning mirror. In some embodiments, the optical chip has silicon photonic optical structures formed with silicon on insulator format. In some embodiments, the optical chip has planar lightwave circuit structures comprising SiOxNy, 0≤x≤2, 0≤y≤4/3.

In a further aspect, the invention pertains to an optical imaging device comprising an optical chip and a lens. The position of the lens determines an angle of transmission of light from a selectable emitting element. In some embodiments, the lens covers all of the pixels, is approximately spaced a focal length away from the optical chip light emitting surface, and directs light from the selectable emitting elements at respective angles in a field of view. In some embodiments, the lens can comprise a microlenses associated with one selectable emitting element. The lens can further comprise additional microlenses each associated with a separate selectable emitting element.

In some embodiments, the optical imaging device can comprise an electrical circuit board electrically connected to the optical chip. The electrical circuit board can comprise electrical switches configured to selectively turn on the selectable optical switches. In some embodiments, a controller is connected to operate the electrical circuit board. The controller can comprise a processor and a power supply. In some embodiments, each pixel can comprise an optical tap connected to the pixel optical waveguide and to a direction coupler. The directional coupler can be connected to a receiver waveguide optically coupled to an optical splitter/coupler optically coupled to the first vertical coupler or optically coupler to the second vertical coupler. The balanced detector can comprise two optical detectors respectively optically connected to two output waveguides from the directional coupler. The balanced detector can be electrically connected to the electrical circuit board. In some embodiments, the optical imaging device can comprise an optical detector adjacent the optical chip. The optical detector can comprise a directional coupler optically connected to a vertical coupler, and a balanced detector. The balanced detector can comprise two photodetectors respectively coupled to an output branch of the directional coupler. The vertical coupler can be configured to receive reflected light from the optical chip and to an optical source from a local oscillator

In other aspects, the invention pertains to an optical array for transmitting a panorama of optical continuous wave transmissions comprising a two dimensional array of selectable optical pixels, one or more continuous wave lasers providing input into the two dimensional array, and a lens system. The lens system can comprise either a single lens with a size to cover the two dimensional array of selectable optical pixels or an array of lenses aligned with the selectable optical pixels. The lens or lenses can be configured to direct the optical transmission from the selectable optical pixels along an angle different from the angle of the other pixels such that collectively the array of pixels covers a selected solid angle of the field of view. In some embodiments, the two dimensional array is at least 3 pixels by three pixels, and wherein the two-dimensional array of optical pixels is on a single optical chip.

In some embodiments, the optical array can comprise at least one additional two-dimensional array of optical pixels arranged on a separate optical chip and configured with a lens system such that each optical chip covers a portion of the field of view. In some embodiments, each selectable optical pixel can comprise an optical switch with an electrical connection such that an electrical circuit selects the pixel through a change in the power state delivered by the electrical connection to the pixel. In some embodiments, the optical switch can comprise a ring resonator with a thermo-optic component or electro-optic component connected to the electrical connection. In some embodiments, the selectable optical pixel can comprise a first vertical coupler that is a V-groove reflector or a grating coupler. In some embodiments, the selectable optical pixel can comprise an optical tap connected to the pixel waveguide, and a monitoring photodetector configured to receive light from the optical tap. In some embodiments, the selectable optical pixel can comprise a balanced detector and a directional coupler that is configured to receive light either from the first vertical coupler or from a second vertical coupler, and to receive portion of light from the row input waveguide. The balanced detector can comprise two photodetectors configured to receive output from respective arms of the directional coupler

In a further aspect, the invention pertains to a rapid optical imager comprising a plurality of optical arrays, wherein the plurality of optical arrays are oriented to image the same field of view at staggered times to increase overall frame speed. In some embodiments, the plurality of optical arrays is from 4 to 16 optical arrays. The plurality of optical arrays can be optically connected to 1 to 16 lasers. The plurality of optical arrays can be electrically connected to a controller that selects pixels for transmission. In other aspects, the invention pertains to a high resolution optical imager comprising a plurality of optical arrays, wherein the plurality of optical arrays are oriented to image staggered overlapping portions of a selected field of view, and a controller electrically connected to the plurality of optical arrays, wherein the controller selects pixels for transmission and assembles a full image based on received images from the plurality of optical arrays.

In other aspects, the invention pertains to an optical chip comprising a light emitting pixel comprising an input waveguide, a pixel waveguide, an actuatable state optical switch, a first splitter optically connected to the pixel waveguide, a solid state vertical coupler, and a lens. The actuatable solid state optical switch can include an electrical tuning element providing for switching selected optical signal from the input waveguide into the pixel waveguide. The solid state vertical coupler can be configured to receive output from one branch of the splitter. The lens can be configured to direct light output form the vertical coupler at a particular angle relative to a plane of the optical chip.

In some embodiments, the optical chip comprises a first optical detector configured to receive output from another branch of the splitter, wherein the first splitter is a tap and wherein the first optical detector monitors the presence of an optical signal directed to the turning mirror. In some embodiments, the optical chip further comprises a second splitter configured between the first splitter and the turning mirror, a differential coupler configured to combine optical signals to obtain a beat signal from the first splitter and a received optical signal from the second splitter; and a balanced detector comprising a first photodetector and a second photodetector, wherein the first photodetector and the second photodetector receive optical signals from alternative branches of the differential coupler.

Moreover, the invention pertains to a method for real time image scanning over a field of view without mechanical motion, the method comprising scanning with coherent frequency modulated continuous wave laser light using a plurality of pixels in an array turned on at selected times to provide a measurement at one grid point in the image wherein the reflected light is sampled approximately independent of reflected light from other grid in the image points; and populating voxels of a virtual four dimensional image with information on position and radial velocity of objects in the image.

In some embodiments, the pixels can comprise optical switches that can be selectively turned on to project light along an angle specific for that switch. In some embodiments, detection of reflected light is performed using a balanced detector in the pixel, or using a balanced detector associated with a row of selectable pixels, or a detector adjacent the array of pixels. In some embodiments, a plurality of arrays of pixels are arranged to scan overlapping spaced apart portions of the field of view. In some embodiments, a plurality of arrays to scan of pixels are oriented to scan the same field of view to increase frame rate. In some embodiments, the scanning is performed with one laser wavelength. In some embodiments, the scanning is performed with a plurality of laser wavelengths. In some embodiments, Doppler shifts are used to determine relative velocity at each point in the image, wherein relative velocities and positions are used to group voxels associated with an object, and where the grouped voxels are used to determine the object velocity.

In other aspects, the invention pertains to a method for tracking image evolution in a field of view using a coherent optical transmitter/receiver, the method comprising: measuring the four dimensional (position plus radial velocity) along a field of view using a coherent continuous wave laser optical array; determining a portion of the field of view as a region of interest based on identification of a moving object; providing follow up measurements directed to the region of interest by addressing the optical array at pixels directed to the region of interest; and obtaining time evolution of the image based on the follow up measurements.

In some embodiments, the optical array can comprise pixels with selectable optical switches to turn on a pixel for emitting light along an angle in the field of view specific for the pixel. In some embodiments, detection of reflected light is performed using a balanced detector in the pixel, or using a balanced detector associated with a row of selectable pixels, or a detector adjacent the array of pixels. In some embodiments, a plurality of arrays of pixels are arranged to scan overlapping spaced apart portions of the field of view and/or are oriented to scan the same field of view to increase frame rate. In some embodiments, providing follow up measurements is performed by performing a scan using pixels with angular emissions for the pixels cover the regions of interest in the field of view. In some embodiments, the method can comprise performing additional scans of the full field of view interspersed with providing follow up measurements.

### BRIEF DESCRIPTION OF THE DRAWINGS

FIG. 1A is a schematic view of a FMCW coherent Lidar configuration.

FIG. 1B is a chart comparing a FMCW Lidar output optical frequency, a received optical frequency with Doppler shift, and a time varying intermediate frequency.

FIG. 2A is an example of a top view of a single prior art LIDAR image Frame capturing 4 cars and 3 pedestrians in motion with different velocities.

FIG. 2B is the image of FIG. 2A as captured by an embodiment of the invention where velocity data is displayed for each voxel through the use of color.

FIG. 3 is a top view illustrating optical beams exiting from a vertical switch array at differing angles.

FIG. 4A is a side view illustrating optical beams exiting from a vertical switch array through a single lens at differing angles.

FIG. 4B is a perspective view of a 2D pixel array with a single lens.

FIG. 5A is a perspective view of a 2D pixel array having a corresponding micro lens array.

FIG. 5B is a top view illustrating the correlation of pixel and lens arrangement with a direction of an exiting optical beam.

FIG. 5C is a schematic side view of three pixels with the left image having an external lens, with the center view having an integral microlens centered over the light emitter to direct a light beam perpendicular to the surface, and with the right pixel having a microlens off-center to direct a light beam at an angle.

FIG. 6A is a perspective top view of a vertical switch array showing a first optical beam exiting a micro lens and a second optical beam entering a micro lens.

FIG. 6B is a side view of the vertical switch array of FIG. 6A.

FIG. 6C is a top view of the vertical switch array of FIG. 6A.

FIG. 7A is a schematic layout of a vertical switch array with each pixel comprising a transmitter and receiver.

FIG. 7B is a schematic layout of a vertical switch array with a detector at the end of each row of pixels that having a transmitter.

FIG. 7C is a schematic layout of a Lidar scanner with a 2D beam steering array of transmitting pixels and an adjacent receiver mounted on a common CMOS integrated circuit.

FIG. 8A is a schematic diagram of an optical chip with a grid like optical pathways in a vertical switch array created by column waveguides and row waveguides with optical switches at the intersection of the columns and rows.

FIG. 8B is a top view schematic diagram of an electrical circuit board with electrical control lines that interface with the vertical switch array of FIG. 8A when the electrical circuit board is soldered to the optical chip.

FIG. 8C is a schematic diagram of the vertical switch array of FIG. 8A having a single optical input signal that can be routed to any row in the array.

FIG. 8D is a schematic diagram of an alternative embodiment of a vertical switch array having a separate optical input signal for each row of the array.

FIG. 8E is a schematic diagram of an alternative embodiment of a vertical switch array having a laser array which generates input optical signals.

FIG. 9 is a schematic fragmentary top view of a exemplary external modulators formed with an electro-optical material along a waveguide.

FIG. 10 is a side view of exemplary pixel vertical couplers with a V-groove and differing lens configurations.

FIG. 11A shows a top view of a waveguide taper and turning mirror.

FIG. 11B shows a side view of the waveguide taper and turning mirror of FIG. 11A.

FIG. 12A is a schematic top view of an exemplary grating coupler off a tapered segment of waveguide at the end of a waveguide.

FIG. 12B is a schematic perspective view of alternative embodiment of a grating coupler.

FIG. 13A is a schematic diagram of a receiver with balanced detectors receiving respective optical signals with a beat frequency from the coupling of a local oscillator with a signal received at a vertical coupler.

FIG. 13B show a transmitter receiver using a single vertical coupler for transmitting and receiving an optical signal, in which a balanced receiver comprises a pair of photodetectors.

FIG. 14A is an exemplary layout of a pixel.

FIG. 14B is an alternative layout of a pixel have two vertical emitters.

FIG. 15 is a diagram showing the Lidar imaging process in which velocity information can be extracted from a single 4F cloud image.

FIG. 16A is an image sensor with a laser chip and a vertical switch array.

FIG. 16B shows four image sensors configured to cover a broader field of view.

FIG. 17A is an exemplary image sensor with a single laser configured to illuminate 16 pixels at the same time and produce 16 simultaneous outputs for improved scanning rates.

FIG. 17B is an alternative embodiment of the image sensor of FIG. 17A with a single laser and amplifies for boosting range configured to illuminate 16 pixels at the same time and produce 16 simultaneous outputs for improved scanning rates.

FIG. 17C is an alternative embodiment of the image sensor of FIG. 17A with four lasers, each configured to illuminate 4 pixels at the same time, thereby producing 16 simultaneous outputs for improved scanning rates.

### DETAILED DESCRIPTION

Optical arrays are configured with a plurality of addressable pixels on an optical chip in which the pixels are configured to emit lights outward from the surface with lenses arranged to direct the emitted light along a particular angle to the surface so that the array can cover a particular solid angle in the field of view. The systems use continuous wave laser light sources to perform coherent, frequency modulated continuous wave (FMCW) operation. The emitted light is generated by a coherent, continuous laser that outputs into waveguides along an optical chip with efficient electronically addressable optical switching to direct the laser light to a selected pixel. An optical chip can comprise a row of pixels with efficient switches, such as tunable ring resonators, and a pixel waveguide that directs the optical signal to a beam steering element that directed the optical signal from the surface of the optical chip, generally through a lens. Various appropriate configurations can be used for the detector. A pixel can comprise various splitters and combiners to tap off optical signals as reference for detection. The pixel can similarly be configured with optical detectors to function as a receiver with the split aperture (two beam turning elements) or a common aperture (single beam turning element), and two optical detectors in a pixel can operate as balanced detectors connected to a directional coupler with inputs connected to the beam splitters such that ne arm of the directional coupler has the received optical signal and the other arm of the directional coupler has the reference signal split from the optical input. In alternative embodiments, one receiver with balanced detectors can be used for a row of transmitting pixels, and in still further embodiments, a receiver can be separate form an optical chip performing the beam steering function. A plurality of arrays ot transmitters can provide wider ranges of the field of view and/or higher frame rates. Efficient and cost effective imaging systems can be designed that can provide effective applications in LIDAR systems.

Optical laser arrays power image generation and receiving that can provide for generation of extensive 4 dimensional data cloud with information on position and radial velocity of objects in the vision field. The ability to track the current position of objects and anticipate future positons is a significant objective of LIDAR that can enable improved autonomous vehicles. The advances described herein are based upon signal generation using one or a plurality of lasers with corresponding optics to provide projection and reception over a broad field of view without a movement-based scanning function. To effectively output the emissions from the laser array along appropriate output directions, a low loss optical switch array provides desired angle resolution. Effective switching functions are used to direct the optical signals along the selected row and column path. Individual pixels perform sending and receiving function to obtain data for the particular direction that is useful for the construction of the 4D image. A processor coordinates the image generation and processing of the image.

Traditional imaging can comprise a scanning function in which the light emitting and/or receiving elements are mechanically moved to scan a scene. To reduce the burden of moving larger elements, mirrors can be configured to steer the transmitted and received beams. Solid state beam steering without moving parts can greatly facilitate the scanning function by avoiding the mechanical motion to direct the beams. More generally, scanning technologies used in today's Lidar devices are either mechanical motion of optics or based on optical phased array techniques. Mechanical scanning is achieved either by rotation of the optical assembly or through mirror like reflector (i.e MEMS). Rotation based techniques are typically considered bulky, shorter life time and costly to manufacture. MEMS based scanner suffer from small FOV, lower frame rate and high sensitivity to mechanical shock and vibration. Optical Phase Array based beam scanning relies on large number of closely spaced optical elements and precise control of each element to direct the beam with low side lobes.

In a FMCW system, laser frequency is linearly chirped in frequency with a maximum chirp bandwidth B and laser output send to the target (Tx signal). Reflected light from the target is mixed with the copy of the Tx signal (local oscillator) in a balanced detector pair. This down converts the beat signal. Frequency of the beat signal represents the target distance and its radial velocity. Radial velocity and distance can be calculated when laser frequency is modulated with a triangular waveform, as described further below. This can be implemented in various ways with respect to scanning the field of view to construct the image. This is performed in the systems herein based on a solid-state beam steering array of pixels with appropriate optics to direct transmitted light to a grid over the field of view and with solid state optical switches performing the switching function. In the context of the discussion herein, stationary refers to the reference frame of the specific Lidar component, such as an optical chip such that it excludes components effectuated by movement, such as MEMS switches or mechanically scanned imaging components, which are not stationary with respect to the Lidar component, and the optical scanning device does not use internal motion for switching. Stationary switches are also sometimes referred to a ‘solid-state optical switches’. Both solid state and stationary, as used herein, refers to no internal motion in the optical scanning device as well as no scanning motion of the optical elements relative to the Lidar device. Thus, the optical switches and the pixel arrays are solid state, which reflects to non-moving parts aspect of the components and their function. Of course, the entire Lidar device can be part of a vehicle so that the entire Lidar system may be moving but herein this issue is not explicitly considered unless explicitly referenced.

Pixel based beam steering described herein allows for using less expensive lasers relative to techniques that rely on phase variance of the adjacent beams to provide a steering function through beam interference. Pixel based beam steering relies on the ability to create effective optical switches with low cross talk integrated along low loss waveguides on an optical chip. A received can be integrated into the chip to provide for a compact transmitter/receiver array. Control of the switching on the optical chip can be performed with an electronic chip, such as a CMOS integrated chip, that can be combined with the optical chip with appropriate aligned soldering. The readily scalable architecture can provide for high resolution and high frame rate.

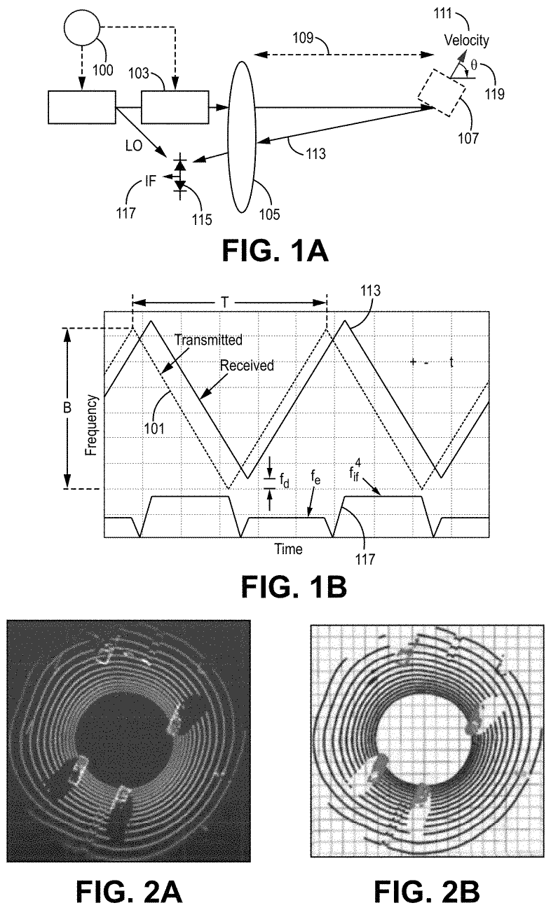

Coherent Lidar (LIDAR based on FMCW) can provide depth and radial velocity information in a single measurement. Velocity information is obtained through the Doppler shift of the optical frequency of the return signal. In potential Coherent Lidar configurations, optical frequency of the laser can be modulated in a triangular form as shown in FIG. 1A. Referring to FIG. 1A, an FMCW Coherent LIDAR configuration is shown for a single pixel output with a reflected signal returned. FIG. 1B shows a plot of the transmitted optical signal and the received optical signal as a function of time along with the IF frequency obtained based on the two signals.

A laser 100, such as a narrow line width laser, transmits an optical signal 101 which may be directly modulated by the laser, or the signal may be achieved through external modulator 103. The modulated signal passes through a lens 105 and reflects off target 107. Target 107 is located at a particular distance, or range, 109 from lens 105. If target is moving, it will also have a velocity 111 and trajectory 119. A time delayed optical reflected signal 113 returns through lens 105 where it is directed to a mixer 115, which can be a directional coupler that blends the received signal with a reference signal split from the optical input.

Frequency modulation of laser light can be archived through an external modulator or direct modulation of laser. Mixing the laser output (local oscillator) with the time delayed optical field reflected from the target generates a time varying intermediate frequency (IF) as shown in FIG. 1B. IF frequency is a function of range. Frequency modulation bandwidth and modulation period. For the case of a moving target, a Doppler frequency shift will be superimposed to IF (shown as change in frequency over the waveform ramp-up and decrease during ramp-down). Note that the Doppler shift is function of target velocity and trajectory.

Referring to FIG. 1B, mixing the reference optical signal 101 with the time delayed optical reflected signal 113 from the target 107 generates a time varying intermediate frequency (IF) 117. IF frequency is a function of range, frequency modulation bandwidth, and modulation period. For the case of a moving target 107, a Doppler frequency shift is superimposed to IF (shown as change in frequency over the waveform ramp-up and decrease during ramp-down. Note that the Doppler shift is function of target velocity 111 and trajectory 119. Extraction of position and velocity from these values is explained further below.

FIGS. 2A and 2B show an example top view of exemplary LIDAR images showing 4 cars and 3 pedestrians in motion with different velocities. In FIG. 2A, which is generated by a conventional LIDAR system, pixels are colored to show the distance measured by a traditional time of flight LIDAR sensor. FIG. 2B shows the same image captured by the proposed Lidar system which provides a 3D image plus radial velocity data for each voxel. In FIG. 2B, voxel colors show speed of each pixel (for clarity distance is not shown). These picture are easy for human brain to identify distinct objects but difficult for computer algorithms to make sense without a prior knowledge. In the case of FIG. 2B, a computer algorithm can be simplified to use velocity data to identify a pixel cluster of an object. In this case, both spatial clustering and velocity based clustering can be combined to provide improved segmentation without use of multiple frames.

For machine vision applications, object classification involves image segmentation in which the voxels (volumetric pixels) in a 3D image frame or frames are identified as clusters of related voxels through methods described in the art. See, for example, Himmelsbach, et al., “LIDAR-based 3D Object Perception,” in Proceedings of 1st International national Workshop on Cognition for Technical Systems, 2008, Borcs, et al., “On board 3D Object Perception in Dynamic Urban Scenes,” in CogInfoCom 2013, 4th IEEE International Conference on Cognitive Infocommunications, Budapest, Hungary, Dec. 2-5, 2013, and Remebida, et al., “A Lidar and Vision-based Approach for Pedestrian and Vehicle Detection and Tracking,” in IEEE, Intelligent Transportation Systems Conference, ITSC 2007, all three of which are incorporated herein by reference. These methods use correlation of distance between voxels to create a cluster to segment the 3D image frame. A majority of these methods are very sensitive to model parameter selection and density of points in the image. In some methods, training is required, see U.S. Pat. No. 9,576,185 B1 to Delp, entitled “Classifying objects detected by 3D sensors for autonomous vehicle operation,” incorporated herein by reference. In most cases, a single image frame may not be sufficient to correctly identify a cluster of voxels that correspond to an object. In these cases, algorithms use multi-frame images to improve segmentation. Especially for object speed and trajectory, multi-frames image processing is required in current algorithms. For further discussion of image segmenting see Douillard, et al., “On the segmentation of 3D Lidar point,” in IEEE International Conference on Robotics and Automation (ICRA), Shanghai, China, 2011.

Of all the sensors, Lidar plays an increasingly important role in 3D perception as their resolution and field of view exceed radar and ultrasonic sensors. In general, Lidar systems can be pulsed, phase coded or frequency modulated continuous-wave (FMCW) lasers. Pulsed Lidar operates by illuminating the scene by laser pulses (˜100 W peak power, ˜1 ns pulse width for 100-200 m range) and measuring the time of flight (TOF) of returned pulses. FWCM LIDAR on the other hand, use continuous wave laser output at low peak power and optically mix the return signal with the reference signal. Coherent mix of return signal and reference signal can provide simultaneously a large dynamic range and excellent ranging resolution.

Each image frame of LIDAR data includes a collection of points in three dimensions (3D point Cloud) which correspond to multiple TOF measurement within the sensors aperture (Field of view-FOV). These points can be organized into voxels which represents values on a regular grid in a 3-dimensional space. Voxels used in 3D imaging are analogous to pixels used in the context of 2D imaging devices. These frames can be processed to reconstruct 3D image as well as identify objects in the 3D image. 3D point cloud is a dataset composed of spatial measurement of positions in 3D space (x,y,z) corresponding to reflection points detected by LIDAR. Reflected light intensity from LIDAR is rarely used by classifiers as objects may be made of multiple materials with varying degree of reflectivity as well as environmental conditions/aging affecting the material reflectivity. Unlike pulsed laser based Lidar systems, Coherent Lidar (LIDAR based on FMCW-Frequency Modulated Continuous Wave) can provide depth and velocity information in a single measurement. Radial velocity information is obtained through the Doppler shift of the optical frequency of the return signal. In typical Coherent Lidar configuration, optical frequency of the laser modulated.

With the above mentioned measurements from the 4D LIDAR, an algorithm is presented that simplifies image segmentation. Based on the image segmentation and the 4D measurements, a lidar module can pre-process image frames and provide not only the X,Y,Z coordinates of Voxel, but also provide radial velocity information (Doppler shift frequency which is related to Voxel radial velocity) as well as segmented bin ID for Voxel s to indicate trajectories of objects in the field of view.

Motionless scanning can be performed with an optical array with light emitting pixels interfaced with a lens or array of microlenses that provide for aiming of output light form the pixels. Scanning the field of view based on the optical array is based on a low loss optical switch, which is described in detail herein based on micro-ring waveguide add/drop structure. One of the advantages of micro-ring add/drop configuration is its off-resonance pass through loss can be very low (i.e 0.001-0.01 dB) depending on the design and waveguide material. See, Bogaerts, et al., “Silicon microring resonators,” Laser Photonics Rev, vol. 6, no. 1, pp. 47-73, 2012, incorporated herein by reference.

A focal plane array consists of an input signal distribution bus section that distributes the input signal(s) to each row, optional modulator section and repeated pixel sections that act as a 1×N optical switch. Each Pixel is made of row signal bus, optical switch and vertical emitter. Light is emitted only when the optical switch in the pixel turned on. At a given time, only one pixel is turned ON in a given row while the other pixels in the same row are set to off. Multiple rows can be turned ON at the same time to enable column scanning instead of pixel-by-pixel scanning. In some embodiments, it can be desirable for the optical intensity to be almost all transferring into the pixel when the switch is on, while in other embodiments, it can be desirable for some residual intensity to continue along the row.

A micro-ring based switch can be turned on and off by adjusting its off-resonance frequency. Depending on the technology used, micro-ring resonance frequency can be changed by current injection, change in temperature or mechanical stress. Alternatively, input laser frequency can be tuned to micro-ring resonances to turn on a pixel or tune to off-resonance to turn-off a pixel. A signal input waveguide can operate as a row signal bus described in the figures described below for focal plane array, and a switch pass through port is connected to the next pixel in the same row. Total loss for the last pixel in the row is a function of number of pixels in the row and the waveguide length/loss. Thus, having extremely small pass through switch loss for each pixel reduces the total loss experienced by the last pixel in the row.

To enable light output from a pixel, drop port of the optical switch is connected to a vertical emitter. In some embodiments, a pixel can use a V-groove reflector to direct light out of plane. In this implementation, a V-groove is etched to waveguide and coated with partial or highly reflector. Partial reflector and photo detector may be used to monitor output optical signal level at the vertical emitter.

Even though a grating based vertical coupler can increase the complexity and introduce additional optical loss, their wavelength sensitivity can be used to fine tune the output angle. Both micro-ring switch operation and the focused grating emitter angle is a function of optical frequency. Thus, by changing optical frequency of the laser, output angle can be adjusted. This can result in finer angle tuning of the configuration of emitted light. In the case of focused grating vertical couplers, orientation of the grating structure can determine the direction of angular tuning at the output.

Coherent Lidar can only measure a single point in 3D space. In order to capture a 3D image of Lidar field of view (FOV), a transmitter beam is directed to different points of the grid within the FOV, which traditionally could be accomplished by scanning in 2D. Using the addressable pixel arrays described herein, each pixel can image a point in the FOV and high frame rates can be accomplished. The reflected light returning from the point projected outward is spread over an angular range such that collection of received reflected light may or may not be based on a receiver positioned adjacent the transmission location. Thus, received light can be collected at a convenient location, but generally based on the receiver location it is desirable to collect as much returned light as practical to improve signal to noise. A higher signal to noise for the receiver can improve the precision of the measurement. Embodiments of the switch based scanners described herein provide integrated receivers within the pixels of the transmitter, which provides a compact construction especially since the received light is referenced relative to a portion of the output light. In alternative embodiments, a receiver can be placed at the end of a row of transmitters to provide for ready access to a reference optical signal and provide for a somewhat larger receiver aperture. In further embodiments, a receiver can be placed adjacent to the transmitter array such that an even larger aperture can be used for the receiver, which simplifying the structure of the optical chip.

Using the beam steering arrays described herein, the field of view can be scanned by activating optical switches to turn on a particular pixel in the array that is structured to direct light along a particular direction. The turning on of the switch begins a measurement for that direction. If the light strikes an object it is reflected back along a cone of angles based on the relative amounts of specular and diffuse reflection as well as dispersion from propagation and scattering from particulates in the air, and other influences on the transmission. The distance to the object determines the time of flight for the returned light. For scanning over the array, one measurement is started by switching on a pixel, and integrating the detected signal over a measurement time such that the total for a pixel measurement is: tₜₒₜₐₗ=t_{switch}+tₘₑₐₛ. The frame rate is the time to scan over the entire field of view, which depends on the resolution, i.e., the number of array grid points. Roughly, a 250×250 grid of points over the field of view can be along the solid angle can be scanned in 16th the time of a 1000×1000 grid of points.

To increase the frame rate, multiple laser frequencies can be used, either through use of a tunable laser or using multiple fixed wavelength lasers tuned to different wavelengths, as long as the wavelength differences are larger than Doppler shifts due to object motion. The different laser frequencies can be simultaneously or overlappingly scanned if multiple detectors can be used to receive separately the different frequency transmissions. Various configurations of receivers described below allow for such scanning. In this way, the frame rate can be multiplied accordingly. Another way to multiply frame rate is to use a plurality of scanning arrays using the same or different wavelengths. If the arrays are sufficiently displaced from each other, the crosstalk between them can be sufficiently low that they can be used to scan the same or displaced portions of the field of view simultaneously or at least in overlapping measurement times. Examples of such embodiments are also shown below.

For scanning with one array with a particular wavelength, the time of flight for the light in getting to the object and reflecting back limits the measurement time. As noted in the previous paragraph, frame rates can be multiplied by using multiple wavelengths and/or using a plurality of scanning arrays. Also, the ability to dynamically control switching in the array can provide a power tool for the efficient improvement in resolution of particular regions of interest in the field of view. After performing a scan of the entire field of view, objects can be identified, moving and/or fixed, and some or all of these can be selected for a limited scan over the field of view. To scan over only a portion of the field of view, selected pixels can be identified, and such a limited scan can be performed over a correspondingly shorter period of time since the number of points scanned is correspondingly smaller than a full scan. Similarly, a full scan can be performed over a small resolution. For example, with a 1000×1000 array, a full scan can be performed over only a 250×250 set of pixels, which can be performed by skipping three of every 4 pixels in a row and three of every four rows in a column, such that the resolution is correspondingly smaller. Of course, the 1 in 4 example is only representative, and any lower resolution selections can be used as desired, such as 1 of 2, 1 or 3, . . . and the like. If the lower resolution scan identifies regions of interest, a higher resolution scan can be performed over the region of interest. The addressable array offers great flexibility for efficient yet effective scanning of the field of view.

In the present application, we present the following:

(1) A Lidar system generating 4 dimensional image (X,Y,Z for 3D location and V (radial) velocity) using a photonic integrated chip consists of a 2D beam scanner and a 2D coherent optical receiver having integral high speed switching function along with pixel selectivity.
(2) A Lidar image processing method that uses high frame rate 4D image with radial velocity information provided by single frame Lidar image to perform image segmentation for object classification and method of calculating object trajectory using a single Lidar image frame that can provide increased efficiency through identifying regions of interest that can be correlated with pixel; selection of the 2D scanner to allow specific increased monitoring of the regions of interest.

### Improved Image Segmentation Using 4D Lidar Output

In dynamic environments, image pixels that belong to a moving object have similar radial velocity to each other regardless of the imaging perspective. Thus, use of radial velocity for clustering voxels in addition to their spatial proximity in a 3D point cloud image enables improved segmentation of the image and more accurately define object boundary. While these pictures are easy for a human brain to identify distinct objects, it is difficult for computer algorithms to make sense of the picture without a prior knowledge. In the case of FIG. 2B, computer algorithms can be simplified to use radial velocity data to identify pixel cluster of an object. In this case, both spatial clustering and velocity based clustering can be combined to provide improved segmentation of the image without use of multiple frames. This provides improved image analysis with a given frame rate. Analysis algorithms are discussed further below.

### Transmitter/Receiver and 2D Beam Steering

Transmitter portions of a Lidar optical circuit provides for output from each of an addressable array of pixels in which the pixels are structures to emit light along a particular direction within the field of view, in which the particular pixels generally direct light along different directions than other pixels. Collectively, the pixels can scan a grid along a solid angle of the field of view by sending and receiving optical signals from each pixel of the array that directs light along a particular grip point in the field of view.

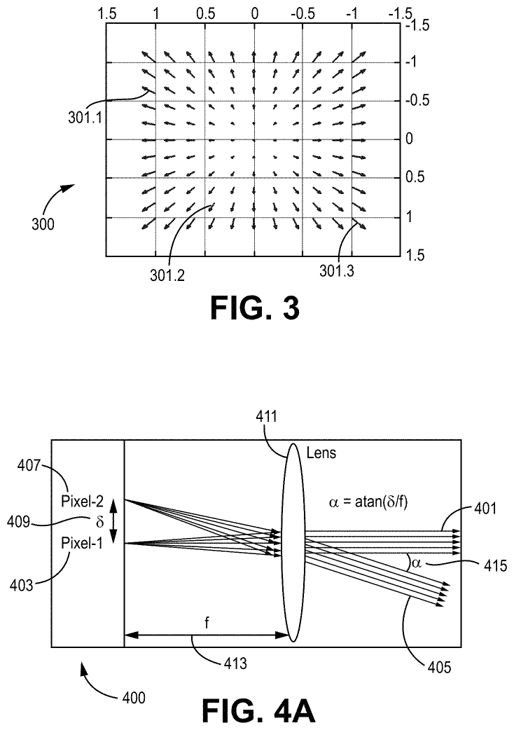

FIG. 3 shows a schematic array of directional vectors for light output from a 2D beam steering array. The solid angle can approach 180 degrees in all directions or a subset of that, as described further below. Optical beams can exit from a vertical switch array at differing angles for each pixel. Referring to FIG. 3, an overhead view is illustrated of optical beams 301.1, 301.2, 301.3, . . . exiting from vertical switch array 300. Each optical beam 301.1, 301.2, 301.3, . . . can exit at a different angle. The optics determine the range of solid angle covered, and the number of pixels determine the angular resolution over that solid angle. If a lower resolution is acceptable, the pixels can scan the same angular direction as another pixel to increase the frame rate for scanning the image.

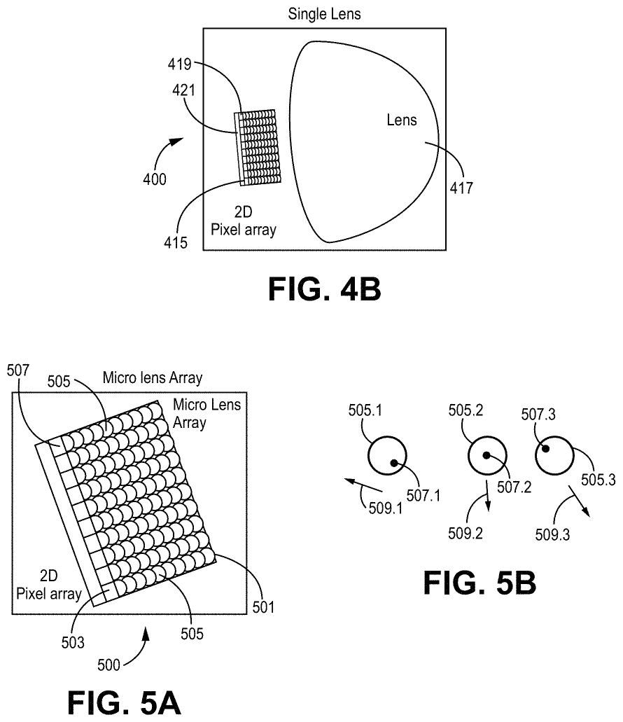

The transmitter function relies on a focal plane array for 2D beam steering, as shown in FIG. 4. Focal plane array consists of low loss optical switches that route the input light along waveguides to M×N output pixel locations on the optical chip. Output of focal plane array is collimated through a lens to illuminate a specific angle in Lidar field of view for each pixel. In other words, each pixel in the focal plane array corresponds to a specific angle in the field of view. A single lens can be used for each array or a microlens can be associated with each pixel.

FIG. 4A illustrates a schematic side view of vertical switch array 400 emitting a first optical beam 401 from a first pixel 403 and a second optical beam 405 from a second pixel 407. First pixel 403 is separated from second pixel 405 by a distance 409. Vertical switch array 400 includes a lens 411 that located a set focal length 413 from first and second pixels 403, 405. First and second optical beams 401, 403 intersect lens 411 at different point of the lens, such that they are directed from the lens at an angle alpha relative to each other. An angle 415, noted as a, between first optical beam 401 and second optical beam 403 may be determined by calculating the arc tangent of the quotient of distance 409, notes as δ, between the pixels and focal length 413 (α=arctan(δ/f)). FIG. 4B illustrates a vertical switch array 400 having a 2D pixel array 415 and a single lens 417. 2D pixel array 415 is an array of light emitting and receiving pixels 419 arranged in a rectangular grid atop an integrated circuit 421. In embodiments, single lens 417 can be shaped as a plano-convex lens with a planar surface oriented toward vertical array switch 400 and positioned such that all light emitted passes through single lens 417 with a corresponding angle for each pixel oriented toward the field of view. Alternative lens embodiments can be used, such as alternative lens configurations or lens systems which can comprise multiple lenses. The electrical integrated circuit is placed over the optical circuit surface away from the light emitting surface so that the lens is on the opposite side from the electrical integrated circuit.

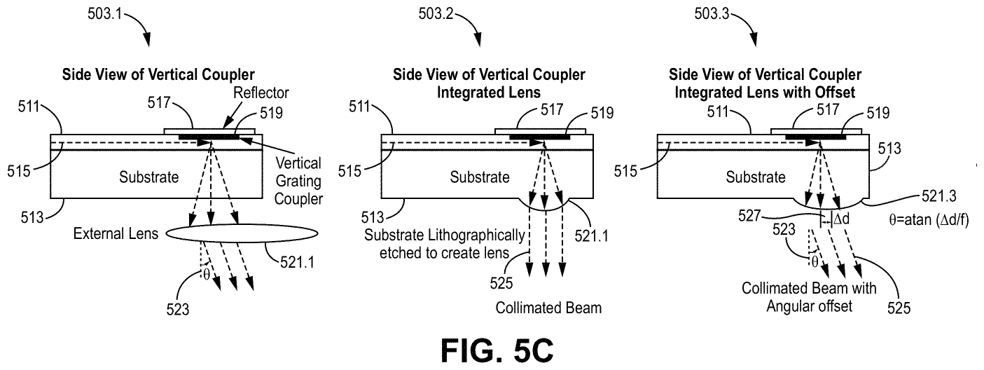

Referring to FIG. 5A, in embodiments, a vertical switch array 500 may use a micro lens array 501 in conjunction with a 2D pixel array 503. Micro lens array 501 consists of a plurality of micro lenses 505 arranged in a grid like structure. The grid like structure follows the shape of the underlying vertical switch array 500. As shown, micro lenses 505 are arranged in a 10×10 grid with 10 micro lenses 505 linearly arranged across a first axis, and a 10 micro lenses 505 linearly arranged across a perpendicular axis. Any reasonable size grid is suitable for a vertical switch array. For example, a grid may in practice have 100 or more pixels along each dimension. Each micro lens 505 in the grid corresponds to a pixel 507 in pixel array 503. For the microlens embodiment, the alignment of a lens and the corresponding pixel determines the angle of transmission relative to the vertical switch array. The appropriate design and placement of the microlenses is generally known in the art. See, for example, published U.S. patent application 2022/0050229 to Lee t al., entitled “Microlens Array Having Random Pattern and Method of Manufacturing Same,” incorporated herein by reference.

FIG. 5B illustrates 3 exemplary arrangements of a micro lens and pixel, along with a corresponding direction of an exiting optical beam. This figure illustrates that the microlens to pixel alignment defines the beam angle. In a first arrangement, a pixel 507.1 generally in the bottom right corner of a micro lens 505.1 results in an optical beam 509.1 that points up and to the left. In a second arrangement, a pixel 507.2 is generally centered with micro lens 505.2, resulting in an optical beam 509.2 that exits straight out. In a third exemplary arrangement, pixel 507.3 is generally in the upper left corner of micro lens 505.3, which results in optical beam 509.3 exiting downwardly to the right.

Referring to FIG. 5C, a side view is shown of three exemplary pixel vertical couplers with differing lens configurations. Pixel 503.1 includes a waveguide 511 beneath substrate 513. Input optical signal 515 travels down waveguide 511 where reflector 517 deflects input optical signal 515 through vertical grating coupler 519 and substrate 513. In the first embodiment shown, lens 521.1 is external to substrate 513. Input optical signal 515 exits lens 521.1 at angular offset θ 523. In the second embodiment shown, substrate 513 of pixel 503.2 is etched, for example lithographically, to create integrated lens 521.2 aligned with vertical grating coupler 519 such that optical signal 511 exits lens 521.2 in a collimated beam 525 having no angular offset. In the third embodiment shown, substrate 513 of pixel 503.3 has integrated lens 521.3 which is offset from vertical coupler 519 by a distance Δd 527. The offset Δd 527 causes collimated beam 525 to exit from pixel 503.3 with angular offset θ 523. In an embodiment based on a spherical lens, the relationship between Δd 527 and angular offset θ 523 may be characterized in θ=atan(Δd/f), where f is the focal length of lens 521.3.

Corresponding receivers receive the reflected optical signals from the transmitters following interacting with the objects in the field of view. The receivers can be integrated with the transmitters into a single array, and efficient structures can be formed through integrating the receivers into the same pixels as the transmitters. Several embodiments of integral pixels with both transmitting function and receiving function are described below.

The transmitter/receiver arrays can be effectively formed from an optical circuit with integral optical switches that provide for addressable pixels. The optical switches can be controlled electrically, such as with resistive heaters that provide a thermo-optical effect, although other electrical induced index of refraction change can be implemented. Also, the receivers have electrical components that involve delivery of power and connection to processors. The optical circuit can be provided with metal contacts during formation that integrate the optical functionalities with appropriate electrical connections. The metal contacts can be furnished with solder balls to facilitate connection, such as to an electrical circuit board, a CMOS chip or other electrical chip structure.

An efficient electrical interface with the optical circuit can be established using a printed electrical circuit board, which can have aligned electrical contacts to interface with the electrical contact on the electrical circuit. The electrical connections with the optical chip electrodes can be made by wire bonding, but in some embodiments appropriate assembly can be performed using mated bonding pads on the electrical submount so that positioning of the optical chip with the electrical submount aligns the bonding pads on each that can then be connected, such as with reflow of solder. Since wire bonding balls would be placed at suitable locations, there can be no concern that they are conductive with no corresponding insulating structures between the elements. Other suitable processing approaches can be used. The electrical printed circuit board can be connected to appropriate processors and drivers.

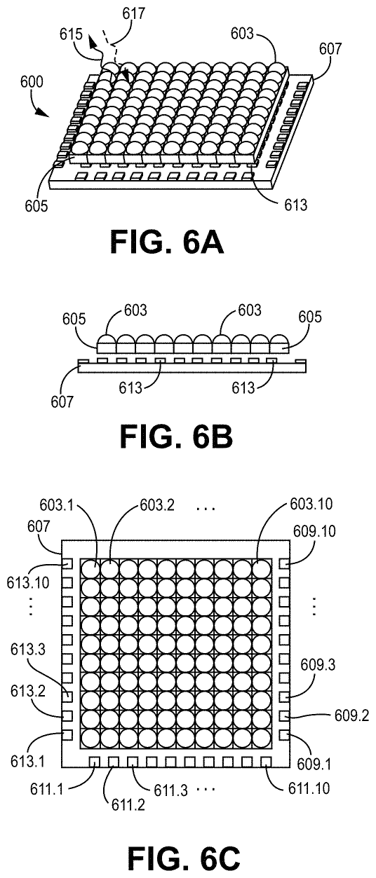

FIGS. 6A-6C illustrate a vertical switch array 600 with a 10×10 grid of micro lenses 603 and corresponding pixels 605 in combination with integrated circuit board 607. Each pixel 605 has a transmitter configured to transmit outbound optical beams 615 and a receiver configured to receive inbound optical beams 617. The transmitter of a pixel has a selectable optical path from a laser light source, and the receiver comprises an optical detector. In this embodiment, each pixel 605 is joined to integrated circuit board 607 through solder bump 613 such that each pixel 605 is electrically connected with integrated circuit board 607, which functions as an electrical power source and an electrical switching device. Each pixel 605 may be individually addressed by integrated circuit board 607 to control optical switching function and to collect output from optical detectors of the receivers. Referring to FIG. 6C, ten columns of micro lenses 603.1, 603.2, . . . , 603.10 are associated with corresponding pixels that are located beneath the micro lenses, and the interface of the microlenses with the pixels is described above with respect to transmitting along different angles.

As shown in FIG. 6C, integrated circuit board 607 has contacts along three sides for addressing pixels 605. Rows may be selected by contacts 609.1, 609.2, 609.3, . . . , 609.10 along one edge of integrated circuit board 607. Columns may be addressed through contacts 611.1, 611.2, 611.3, . . . , 611.10 along another edge of integrated circuit board 607 and pixels along a row can be selectively accessed with contacts 613.1, . . . 613.10. With a suitable configuration and number of contacts, selection of a pixel for transmission can be accomplished and reception of optical detector signals can be achieved also. As discussed above, a 2D pixel array may have grids of desired dimensions can be used to achieve design specifications within practical constraints, such as substrate process sizes and efficient pixel dimensions. The number of electrical contacts for the circuit board 609, 611, 613 can be adjusted based on the number of pixels and the corresponding functionality. Further the system is scalable to larger arrays by connecting multiple vertical switch arrays to a communications bus, as described further below.

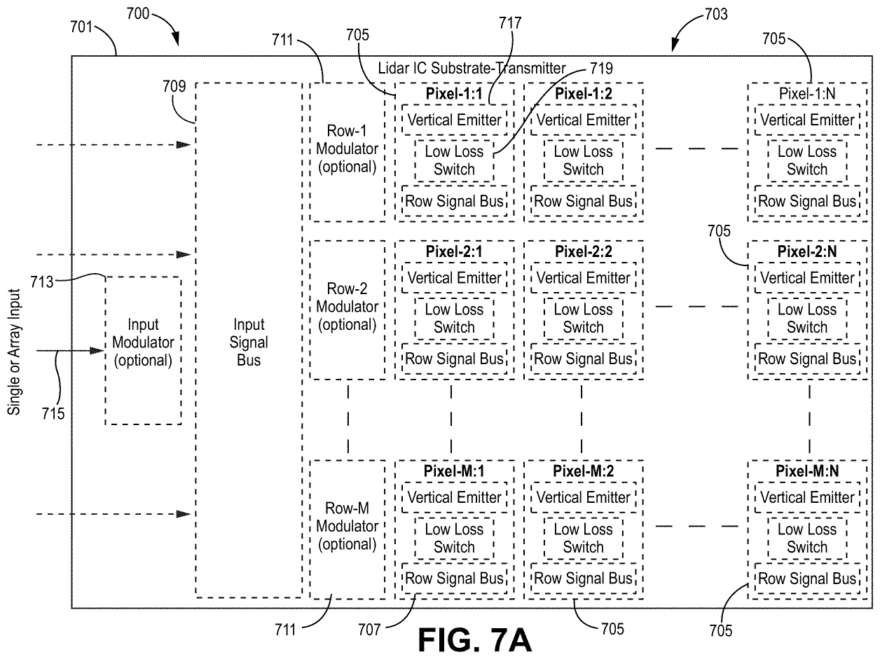

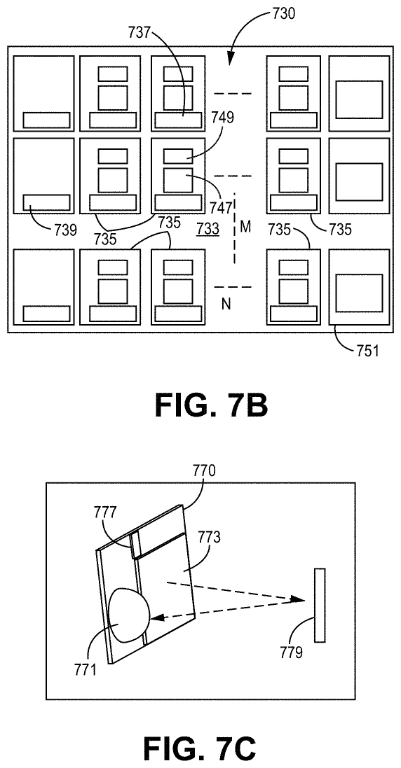

FIGS. 7A-7C provide three embodiments of a schematic layout of an optical circuit, which can be provided on an optical chip, in which the transmission functions are depicted. FIGS. 7A-7C differ from each other based on the position of the detector. To form the array, there are a series of columns and rows. While various optical chip technologies can be adapted to this application, in principle, silicon photonics can be particularly desirable, based on silicon on insulator processing in which silicon waveguides are formed and air can provide cladding. A general description of the use of silicon photonics for such an application is described in Sun, et al., “Large-Scale Silicon Photonic Circuits for Optical Phased Arrays,” IEEE Journal of Selected Topics in Quantum Electronics, VOL. 20, NO. 4, July/August 2014, incorporated herein by reference. In alternative embodiments, the optical chip can be based on planar lightwave circuit technology using SiOₓN_{y}, 0≤x≤2, 0≤y≤4/3, where 2x+3y can be approximately 4. The formation of silica based structures is well known and formation of silica-based optical splitter/combiners are described in U.S. Pat. No. 10,330,863 to Ticknor et al., entitled “Planar Lightwave Circuit Optical SplitterMixer,” incorporated herein by reference. Silicon nitride and silicon oxinitride can be similarly processed. See also, Tiecke, et al., “Efficient Fiber-Optical Interface for Nanophotonic Devices,” Optica Vol. 2(2), February 2015 70-75, incorporated herein by reference. Each row has an input waveguide that provides light to the row. Each pixel then has a low loss switch that is used to capture light from the input waveguide when the switch is turned on. When the switches are off, the light progresses down the input waveguide to access the down-path pixels. As described in detail below, a laser light source can be supplied for each row, or a feed waveguide can supply light to all or a subset of the rows. If a feed waveguide is used, switches can direct light to the row from the feed waveguide. The switches for a row can be wavelength selective in an always on state or they can be tunable to selectively turn the switch on and off through an electrical signal, and switch design generally depends on the light source, monochromatic or polychromatic. Modulators for the laser light can be built into the lasers, alternation positions along the optical path, or placed at appropriate positions along the light path leading to a row (external modulators).

Referring to specific features of FIG. 7A, a schematic layout of vertical switch array 700 is illustrated as an integrated optical chip 701. 2D pixel array 703 is a series of pixels 705 organized into M rows and N columns on an integrated optical chip, creating an M×N array of pixels 705. Each pixel 705 has a row signal bus (waveguide) 707 connected to an input signal bus (waveguide) 709. Input signal bus 739 can be a waveguide connecting to a laser or a waveguide with a row switch from which a laser signal provided for multiple rows can be selectively switched into a row. Effectively, the row signal buses 707 of the pixels in a row form a continuous waveguide that provides low loss across the row when passing off switches although the structure of the waveguides reflects their interactions with the low loss switch of each pixel. In embodiments, each row can have a row modulator 711 between the input signal bus (waveguide) 709 and the row signal bus (waveguide) 707. In alternative embodiments, an input modulator 713 may be placed between optical input signal 715 and input signal bus (waveguide) 707 such that all signals are modulated before they reach input signal bus waveguide) 707. In embodiments, optical input signal 715 may be modulated prior to being received by integrated chip 701, such as at a laser source. In such embodiments, integrated chip 701 does not require either input modular 713 or row signal modulator 711. In some use cases, placing a row modulator 711 at each row of the vertical switch array 700 may reduce cross talk, particularly when steering involves the use of multi-beams. Each pixel 705 further comprises a low loss switch 717 connected between the row signal bus (waveguide) 707 and a vertical emitter 719. When activated, low loss switch 717 routes optical input signal 715 from the row signal bus 707 to vertical emitter 719. When low loss switch 717 is deactivated, input signal 715 does not reach vertical emitter 717.

Referring to FIG. 7B, an alternative layout of a vertical switch array 730 involves the placement of a receiver at the end of each row of transmitting pixels. This configuration allows for a simpler pixel design and a larger aperture receiver while taking advantage of the local oscillator available on the row signal bus. Referring to FIG. 7B, 2D pixel array 733 comprises a series of transmitter pixels 735 organized into M rows and N columns on an integrated optical chip, creating an M×N array of pixels 735. Each pixel 735 has a row signal bus (waveguide) 737 connected to an input signal bus (local oscillator waveguide) 739. Input signal bus 739 can be a waveguide connecting to a laser or a waveguide with a row switch from which a laser signal provided for multiple rows can be selectively switched into a row. In some embodiments, the row signal buses 737 of the pixels in a row form a continuous waveguide that provides low loss across the row when passing off switches although the structure of the waveguides reflects their interactions with the low loss switch of each pixel.

In embodiments, each row can have a row modulator between the input signal bus (waveguide) 739 and the row signal bus (waveguide) 737, although in FIG. 7B, it is assumed that the signal from input signal bus 739 is modulated. In alternative embodiments, an input modulator may be placed between an optical input signal and input signal bus (waveguide) 739 such that all signals are modulated before they reach row signal bus 737. In embodiments, optical input signal may be modulated prior to being received by vertical switch array 730, such as at a modulated laser source. In such embodiments, vertical switch array 730 does not have either input modular or row signal modulator. Each transmission pixel 735 further comprises a low loss switch 747 connected between the row signal bus (waveguide) 737 and a vertical emitter 749. When activated, low loss switch 747 routes an optical input signal from the row signal bus 737 to vertical emitter 749. A switch turned on can direct most of the light into the pixel while leaving a residual amount of light, e.g., 10%, for transmission to the detector to serve as a reference signal to modulate the received optical signal. In some embodiments, the row signal bus 737 can comprise a tap with a detector waveguide to receive a fraction of the input optical signal, such as 10% for transmission to the detector, while directing the remaining light to a row waveguide to provide optical signal to the pixels through their respective switches. In either of these configurations, row detector 751 receives an appropriate reference optical signal. Row detector generally comprises a vertical coupler to received the reflected signal, a directional coupler to couple the reference local oscillator signal with the received optical signal and a balanced detector with two photodectors to measure the beat signal output from the directional coupler. When low loss switch 747 is deactivated, input signal does not reach vertical emitter 747, and the optical signal continues down row signal bus 737. While reference numbers are not fully populated in FIG. 7B to keep the figure from being excessively cluttered, the transmitting pixels 735 in the M×N array are generally equivalent to each other. Structures for the receiver are described more fully below, but basically a receiver with have a vertical coupler such that the received light can be directed to a differential coupler for mixing with the local oscillator (optical signal from the row signal bus) and then directed to balanced receiver with two optical detectors. Generally, the vertical switch array 730 has M equivalent optical detector pixels.

Referring to FIG. 7C, an embodiment of a Lidar Integrated (No Movement) scanner 770 is depicted with a single receiver 771 for an array of transmitting pixels on an optical chip 773. As shown, optical chip 773 and receiver 771 are mounted on a common electrical circuit board 775, which can be a CMOS integrated circuit. Receiver 771 generally has its own lens to focus incoming light onto vertical coupler to direct the light to a photodetector. As shown in FIG. 7C, a narrow line width laser 777 is mounted abutting optical chip 773. To extract the position information from the received optical signal, the received optical signal should be coordinated with a transmission into a specific angle in the field of view. Thus, once a transmission pixel is turned on and then off, some period of time is allowed for the light to strike an object and return. The time for the light to return depends on the distance to a target 779, and can be on the order of a microsecond. This embodiment has an advantage of allowing for an even larger aperture receiver, and the ability to collect more light can allow for an improvement in the signal to noise for the receiver. Also, a tap of the laser input light can be directed efficiently to the receiver to function as a reference local oscillator to allow for effectively instantaneous reception of light as soon as light is transmitted from a pixel in the steering array.

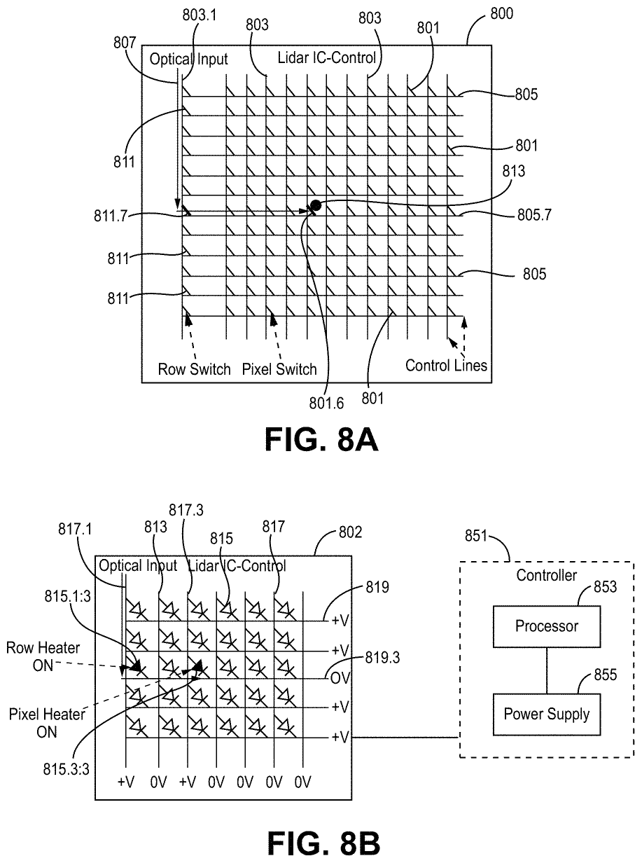

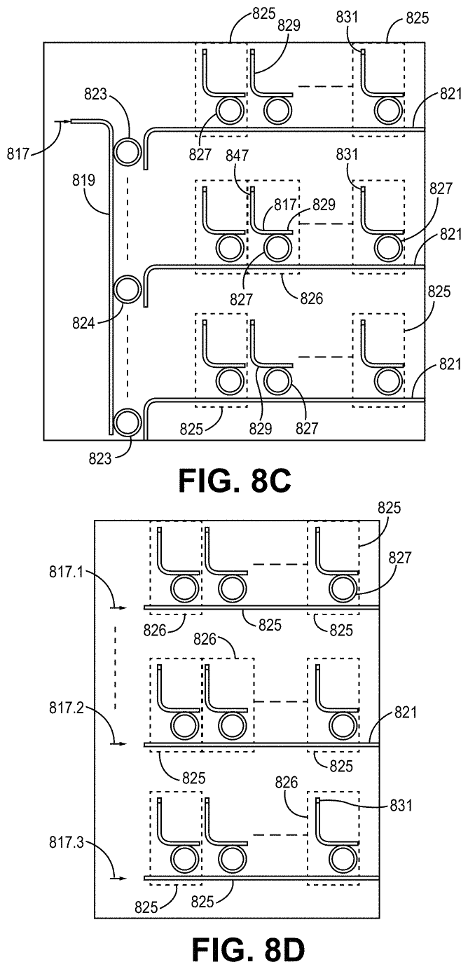

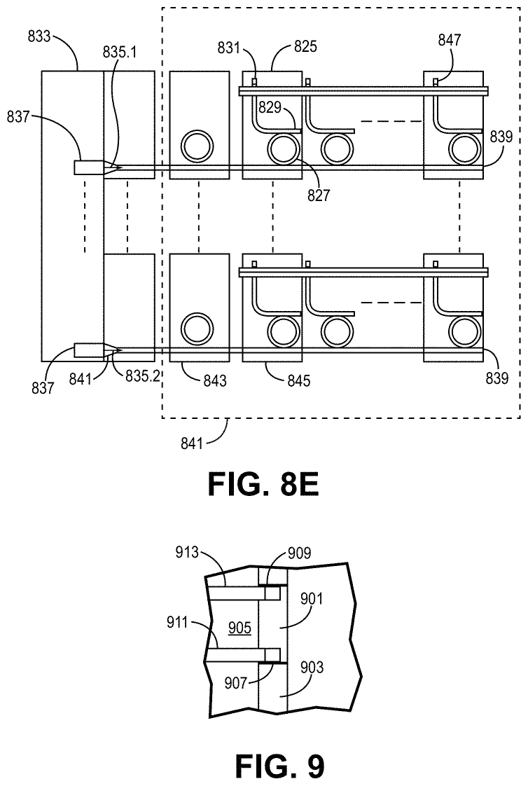

Pixels generally are controlled through coordination of electrical signals and optical switches. Referring to FIGS. 8A and 8B, the optical switches are activated by the electrical circuit, which can be provided by an associated electrical circuit board, such as a CMOS integrated circuit. The optical switches provided on an integrated optical chip 800 are noted in FIG. 8A. The corresponding electrical currents of an electrical circuit to activate the optical switches are noted in FIG. 8B. With respect to transmissions, the corresponding optical switches, associated optical waveguides and electrical pathways are shown schematically, respectively, in FIGS. 8A and 8B. The grid like structure shown represents optical waveguides with optical switches (FIG. 8A) and electrical control lines (FIG. 8B) connected to contacts of an integrated circuit, embodiments of which are detailed above, such that each optical row switch and optical pixel switch may be addressed. Referring to FIG. 8A, optical row switches 811 are shown generally at the intersection of first column 803.1 of the array and row control lines 805. Optical pixel switches 801 are shown generally at the intersection of each row control line 803 and column control line 805. Optical input signal 807 is routed along a waveguide corresponding to the first column of the array until it encounters an activated optical row switch 811.7 which redirects optical input signal 807 to travel down row 805.7. When optical signal reaches an activated optical switch 801.6, it is once again diverted, and this time exits the associated pixel through a vertical emitter 813. Optical switches 801, 811 can be activated by initiating a heater associated with the switch or other activated electro-optical effect.

Referring to FIG. 8B, electrical switches 815 have a first set of electrical connection along a column 817, and a second set or orthogonal electrical connection along a row 819, with appropriate insulation not shown to insulate intersections and avoid a short circuit. As shown, two electrical switches (diodes) 815.1:3, 815.3:3 in the array are activated. An electrical switch (diode) is activated by creating an electrical differential across the switch/diode. For example, a switch may be activated by applying a positive voltage to a first connection of the switch and a zero voltage to the second connection of the switch. In the example shown in FIG. 8B, the first and third columns 817.1, 817.3 have a positive voltage, and all remaining columns have a zero voltage. All rows 819 have a positive voltage with the exception of the third row 819.3 which has a zero voltage. As such there are only two switches 815.1:3, 815.3:3 with a voltage differential between the connections. Specifically the first switch 815.1:3 in the first column 817.1 and third row 819.3, which is associated with a row optical switch, and the third switch 815.3:3 at third column 817.3 of the third row 819.3:3, which is associated with an optical switch in a pixel. As part of the Lidar system, a controller 851 comprises a processor 853 and power supply 855, and controller 851 can be integral with circuit board 802, separate but electrically connected to circuit board 802 or some combination thereof.

FIGS. 8C through 8E depict representative schematic layouts of an optical chip with addressable pixels. Specifically, FIGS. 8C through 8E illustrate the waveguides and optical switches associated with a pixel array. For transmission, the optical signal travels along a row until it reaches the first open optical switch, at which point the optical signal is diverted into the pixel. The optical signal continues along a pixel waveguide to a vertical emitter element. The vertical emitter reflects the planar optical propagation into a vertical transmission through the substrate to the lens to direct the light into the specific direction for that pixel structure.

In the embodiment shown in FIG. 8C, a single optical input signal 817 is used for the entire array with representative components noted with reference numbers. In the single input signal embodiment, the array includes a waveguide 819 along the first column, and a waveguide 821 along each row. A micro ring is used as a row optical switch 823. 824 to divert the single optical signal to a particular row in the array. As depicted in FIG. 8C, 823 are off-switches and 824 is the on switch such that optical intensity noted with the arrows switches at switch 824 into its row. Each row has pixels 825, 826 which include a micro ring resonator 827 and waveguide 829 with a vertical emitter 831. When a pixel's 825 micro ring resonator 827 is activated (pixel 826, with off pixels being 825), the input signal 817 travelling down the row waveguide 821 diverts the signal 817 to the pixel's 825 waveguide 829, which, in turn, directs the signal to exit through the vertical emitter 831. Arrows in the waveguides indicate an input signal diverted into a row and subsequently into activated pixel 826. Using inputs with multiple wavelengths permits multiple pixels to simultaneously emit signals, enabling multi-beam scanning, as shown in FIG. 8D.

Ring resonators can be formed using localized heating elements and trenches to isolate heat flow. These designs for the ring resonators can be more efficient and have faster response times. Efficient ring resonator designs as described herein are described further in published U.S. patent application 2020/0280173 to Gao et al. (hereinafter the '173 application), entitled “Method for Wavelength Control of Silicon Photonic External Cavity Tunable Laser,” incorporated herein by reference.

Referring to FIG. 8D, an array may receive multiple optical signal inputs 817.1, 817.2, 817.3. For example, each row may be associated with a different input laser 837. In embodiments, each input laser may produce a signal in a different wavelength. Providing differing input signals 817.1, 817.2, 817.3 directly to each row of the array eliminates the need for a waveguide along the first column as well as the row optical switches. The use of different wavelengths allows for the simultaneous transmission of light from different pixels of the array. Each row has pixels 825, which include a micro ring resonator 827 and waveguide 829 with a vertical emitter 831. When a pixel's micro ring resonator 827 is activated, the input signal 817 travelling down the row waveguide 821 diverts the signal 817 to the pixel's waveguide 829, which, in turn, directs the signal to exit through a vertical emitter. As depicted in FIG. 8D, each of the three rows has an active, transmitting pixel 825, which is available due to three distinct wavelengths. Each row may or may not also have a row switch depending on the input configuration of the remaining rows, and pixels in the remaining rows may or may not have simultaneously active pixels depending on the wavelengths of light provided to these rows.

In the embodiments shown in FIG. 8E, the vertical emitter or coupler function is provided by a V-groove reflector bar 847. In this embodiment, the pixels are designed for transmission function only, so receivers can be provided at the end of a row, such as shown in FIG. 7B or with an adjacent receiver, such as shown in FIG. 7C. While separate V-groove reflectors can be provided separately for each pixel, as shown in FIG. 8D, a single V-groove reflector s formed for each row separately coupling into a pixel waveguide for each pixel in the row. The use of a V-groove reflector is not dependent on the use of a separate light source for each row, so grating vertical couplers can be used in the pixels of FIG. 8D, and similarly, a V-groove reflector for vertical coupling can be used as an alternative to grating vertical couplers in the embodiments of FIGS. 8A-8C.

Coherent Lidar is performed with FMCW (frequency modulated continuous wave) lasers. In general, tunable lasers can be used, or fixed wavelength lasers can be used, which can provide a cost savings. Modulated laser light should be provided to the pixels. The light can be provided by one or more lasers, and the configuration is influenced by the laser selection. With the use of low loss optical switches, correspondingly less laser power can be sufficient, although the optical circuit can include optical amplifiers as needed. Solid-state lasers can be effectively used to supply the laser power, although alternative lasers may be used. In some embodiments, the lasers can be integrated into the optical circuit. In other embodiments, a laser or array of lasers can be provides on a separate optical chip, and the laser optical chip can be optically connected with the optical chip forming the switched array functioning as transmitter/receiver.

Solid state tunable lasers are described, for example, in the '173 application cited above. A high power tunable silicon-photonics based laser is available from Applicant NeoPhotonics Corp. An array of separately controllable laser diodes is described in U.S. Pat. No. 9,660,421 to Vorobeichik et al., entitled “Dynamically-Distributable Multi-Output Pump for Fiber Optic Amplifier,” incorporated herein by reference. The laser power can be correlated with respect to the number of laser used, the number of pixels that may be powered simultaneously loss in the system and range for the imaging. In general, the laser powers are up to 100 mW (20 dBm), although more powerful lasers could be used.

FIG. 8E illustrates an optional laser array 833 that may be used to provide a plurality of optical input signals 835.1, 835.2 for a vertical switch array. Laser array 833 includes a plurality of lasers 837 that direct a signal to row waveguides 839. In embodiments, laser 837 may be directly to row waveguide 839 through mode converter 841. In embodiments, splitters may be used to connect a laser to multiple row waveguides. For example, a first laser could have its output split into four signals which are coupled to the first four rows of a vertical switch array, a second laser could have its output split into four signals which are coupled to the fifth through eighth rows of a vertical switch array, and so on and so forth. In embodiments, optical input signal 837 passes through a modulator 843 before reaching pixels 845. In embodiments, modulators may be incorporated into laser 837 or laser array 833 or on optical chip.

Referring again to FIG. 7, modulators can be placed at various parts of the system. In particular, a modulator can be placed optionally on the optical chip along the waveguide at the input line leading to an input signal bus connecting the row, or optionally along a waveguide providing input into a row. As noted above, the optical signal can be modulated prior to reaching the optical switch chip, and these embodiments are described further below. Straightforward modulation can be effective, such as modulation with a triangular frequency variation, as shown in in FIG. 1B.

Some lasers are suitable for direct modulation, in which the laser light output is modulated through control of the laser tuning. In other embodiments, external modulators are used. Suitable external modulators include, for example, electro-optic modulators. The electro-optic modulators can be formed through doping a section of the waveguide and attaching electrical contacts. The electro-optic modulator varies the phase, but through time dependent phase variation, the frequency is correspondingly modulated. So the electric signal driving phase variation is modulated according to the desired frequency modulation.

The selection of the number of lasers can be based on the size of the pixel array, the desired number of frames per minute, the desired range of the imager, laser properties and other design considerations. The number of lasers can be 1 or more than 1, in some embodiments no more than 100 lasers, but in generally the number of lasers is not generally constrained except by practical considerations of size and cost. The laser power can be from about 20 mW to about 5 W, in some embodiments from about 45 mW to about 2 W, and in other embodiments from about 75 mW to about 1 W. The lasers can be fixed wavelength solid state lasers, such as a laser diode—distributed feedback laser. While each array of pixels can be driven by a plurality of lasers, a single laser can effectively drive a plurality of arrays. Fixed wavelength lasers can be supplied at lower cost relative to tunable lasers. A person of ordinary skill in the art will recognize that additional ranges of laser power within the explicit ranges above are contemplated and are within the present disclosure.

The design of the laser interface with the pixel arrays can be guided by laser selection, number of pixels, and design of the switching functions. With one laser powering all transmittance, then the switching function accommodates all of the pixel selection and operation. A plurality of lasers can be used, which can either be fixed wavelength or adjustable wavelength and can be configured to transmit along the same waveguides or distinct waveguides from each other. If different wavelengths are directed along a common waveguide, these wavelengths can be multiplexed using an optical combiner, and wavelength selective switches along an array feed waveguide can be used for demultiplexing such that a particular wavelength can be directed down a row. In some embodiments, a single wavelength of light is directed down a feed waveguide, and a switch is activated to direct the light down a selected row.

In additional or alternative embodiments, lasers can be provided for each row. With this configuration, the rows do not need switches for row selection. The lasers can be connected abutting the optical chip with the laser coupled into the row waveguide, or any other reasonable connections for optical elements known in the art can be used, such as features for connecting optical fibers to optical chips.

To switch a pixel into an on state for transmitting and subsequent receiving, two switches can be placed in the on position, a row selector switch and a pixel selector switch. If the row has a separate input, there may not be a row selector switch. In general, it is most efficient to have the switch in a default off mode such that the switch is actuated to turn the switch on. Turning a switch on generally involves application of an electric current to engage some optical change, such as a change of index of refraction. A thermo-optical effect can be useful to effectuate this change of index of refraction, and ring resonators are described herein to operate as a low loss optical switch. A row selective switch can be a fixed wavelength selective switch or an actuatable switch analogous to a pixel selective switch. Alternatively, a row can have a dedicated input so that only a pixel switch is turned on to direct light into the pixel for transmission in the selected direction.

FIG. 9 shows an embodiment of an optional external modulator 901 placed along a section of waveguide 903 located on an optical chip 905 in a fragmentary view. The various embodiments of the optical switch arrays on an optical chip describe the alternative placements of the modulator shown n FIG. 9, which has a fragmentary view that can be placed accordingly in the appropriate location. External modulator 901 can be an electro-optical material placed into the waveguide or on its surface appropriately. For example, for a silicon waveguide, dopants can be placed into the waveguide at the external modulator to provide the electro-optical properties. Electrodes 907, 909 are placed at respective ends of external modulator 901 to provide current to induce the modulation. Contacts 911, 913 connect electrodes 907, 909 to an electrical circuit, such as shown in FIG. 8B. The electrical fields from an applied current provides phase modulation of an optical signal transmitting through the waveguide, and time variation of the electrical current according to the desired modulation to provide the corresponding frequency modulation of the optical signal.

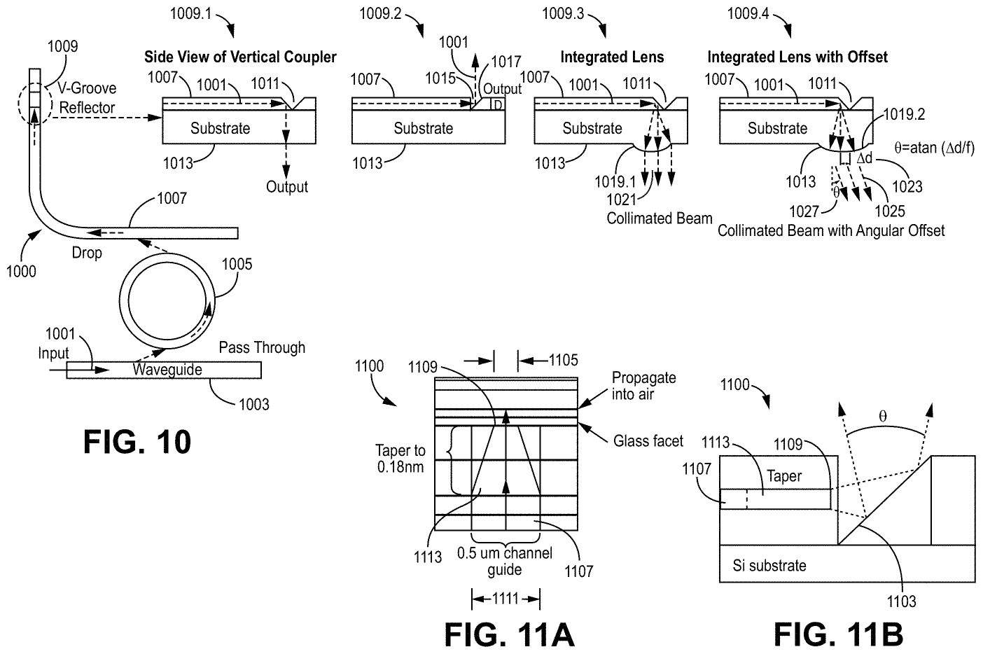

Suitable vertical emitter elements can be a mirrored V-groove. Referring to FIG. 10, a V-groove can be adapted to reflect the light in a vertical direction either through the substrate or away from the substrate. Referring to FIG. 10, a portion of a pixel 1000 is shown on the left of the figure having an optical input signal 1001 passing from a row waveguide 1003, through low loss switch 1005, and into the pixel waveguide 1007 where it is emitted through a V-groove reflector 1009. In embodiments, V-groove reflector 1009 includes a V-groove 1011 etched into waveguide 1007. The arrow in the figure then points to representative embodiments based on the V-groove structure.

Specifically, four exemplary embodiments of V-groove reflector 1009 are shown in FIG. 10 to the right of the arrow. In a first embodiment 1009.1, V-groove 1011 redirects optical signal 1001 through a substrate 1013 and through an external lens (not shown). Portions of V-groove 1011 may be coated with reflective materials. In embodiments, V-groove 1011 may be metalized. See for example, U.S. Pat. No. 9,052,460 to Won et al., entitled “Integrated Circuit Coupling System With Waveguide Circuitry and Methods of Manufacturing Thereof,” incorporated herein by reference.

In a second embodiment 1009.2, V-groove 1011 has a non-reflective face 1015 allowing optical signal 1001 to pass through, and a reflective face 1017 that directs optical signal 1001 to exit the pixel away from the substrate. While reflective face 1017 can be metalized, it can be less desirable than alternative structures since non-reflective face 1015 should be free of metal to be highly transmissive. In embodiments, V-groove 1011 may be filed with an appropriately shaped deposit of reflective polymers to form reflective face 1017. Accordingly, various pixel orientations within an array are achievable with changes to the orientation of V-groove reflector 1009.

In the third embodiment shown 1009.3, substrate 1013 of pixel 1000 is patterned to create integrated lens 1019.1 aligned with V-groove 1011 such that optical signal 1001 exits lens 1019.1 in a collimated beam 1021 having no angular offset. In the fourth embodiment shown, substrate 1013 of pixel 1000 has integrated lens 1019.2 which is offset from V-groove 1011 by a distance Δd 1023. The offset Δd 1023 causes collimated beam 1025 to exit from pixel 1000 with angular offset θ 1027. Integrated lens 1019.2 may or may not be a spherical lens. For a spherical lens, the relationship between Δd 1023 and angular offset θ 1027 may be characterized in θ=atan(Δd/f), where f is the focal length of lens 1019.2 and other shaped lenses can be used to achieve desired angular propagation as determined by geometric optics.

An embodiment of a polymer based turning mirror suitable for the embodiment of the V-groove vertical deflector is shown in FIGS. 11A and 11B. FIG. 11A shows a top down view and FIG. 11B shows a side view of a waveguide taper and turning mirror. Turning mirrors fabricated in oxide trenches using polymers with gray-scale lithography have been demonstrated in Noriko, et al., “45-degree curved micro-mirror for vertical optical I/O of silicon photonics chip” Optics Express vol 27, No. 14 8 Jul. 2019, incorporated herein by reference. However, using a smaller spot and a larger divergence saves space on the chip. A significant design parameter of the vertical emitter is the length of the taper. The minimum width of the guide at the taper tip is set by process rules, and can be kept fixed at the minimum size of 0.18 microns. If the taper is too short, the mode will not have time to expand. This will cause high reflection and low throughput to the turning mirror. The optical power is integrated at planes just inside the SiO₂ facet, and 1 micron past the facet in air. The general trend is for higher transmission loss as the taper length is reduced. The difference between the air and glass transmissions is Fresnel reflection at the facet of air/glass interface. As the taper becomes shorter, and the mode is smaller, there are high angle plane wave components of the optical mode. The wider range of incidence angles increases overall modal reflectivity.

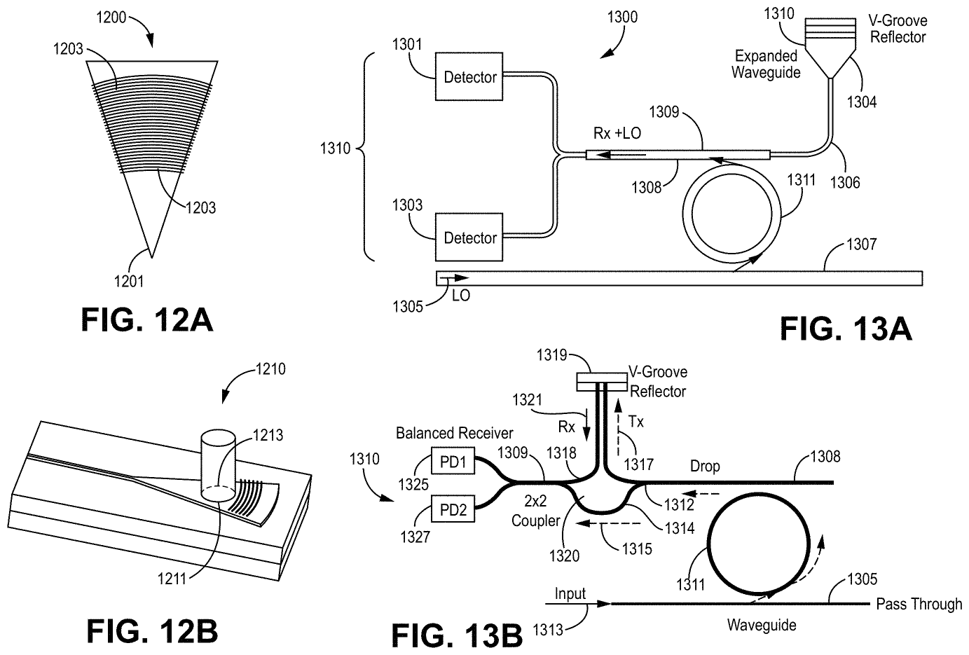

In alternative embodiments, surface grating couplers can be used to perform vertical turning of the optical path. A representative surface grating coupler is shown in FIG. 12A. Design and construction of grating couplers are described further in published U.S. patent application 2021/0373232 to Ishikawa et al., entitled “Optical Connection Structure,” and 2022/0026649 to Vallance et al., entitled “Optical Connection of Optical Fibers to Grating Couplers,” both of which are incorporated herein by reference. Relative to the structures in these referenced applications, the grating couplers would propagate into free space rather than into an optical fiber. The efficiency of a surface grating coupler in this configuration can be improved by applying metal on the opposite surface of the substrate through which the light is transmitted such that light does not leak out that surface and is reflected by the metal.

Standard silicon photonics surface gratings are on the rough order of magnitude of tens of microns or less, possibly into single digits of microns. To support further shrinking the pixel size, a more compact method of launching the light vertically is desirable. The grating coupler shown in FIG. 12A is designed to create an approximately 8 micron MFD (mode field diameter) spot with an numerical aperture of 0.1 to match to standard single mode fibers. By tapering the 0.5 micron channel waveguide down to 0.18 micron, the optical mode is expanded into the SiO₂ cladding, allowing it to efficiently radiate from the high index silicon.

In an alternative embodiment, as shown in FIG. 12B, grating coupler 1210 may have a micro-ring 1211 with integrated grating 1213. As the focused grating emitter angle is a function of optical frequency, by changing optical frequency of an optical signal, an output angle of the signal can be adjusted. Accordingly, including a micro-ring 1211 with integrated grating 1213 allows for finer angle tuning of emitted signal. In the case of focused grating vertical couplers 1200, 1210, orientation of the grating structure can determine the direction of angular tuning at the output. In this configuration, light is vertically emitted from the micro-ring. Further description of these structures is found in Werquin, “Ring Resonators With Vertically Coupling Grating for Densely Multiplexed Applications,” IEEE Photonics Technology Letters, vol. 27, no. 1, pp. 97-100, Jan. 1, 2015, incorporated herein by reference.

A particularly compact structure combines the receiving function with the transmitting function within a pixel. This can provide a structure in which the transmitted signal can be split for use as a reference signal for evaluating the received signal in a short span of waveguide. Either the vertical emitter element for transmission is used for receiving or a parallel structure is used for receiving, which can be located adjacent the transmitter element. In either case, the elements can use the same lens. FIG. 13 shown embodiments of a stand alone receiver or a combined transmitter receiver pixel

Thus, a pixel within the array of pixels can comprise an optical switch to turn on the pixel with respect to receiving input laser light. The input light can be split with a portion of the light directed to a receiver to provide a reference for the received signal. Optionally, a tap can remove a portion of remaining signal to direct to a receiver component, such as a photodiode for monitoring. The monitoring receiver can confirm activation of a pixel. The remaining light signal can be directed to a vertical coupler. As noted above, the same vertical coupler can be used as a receiver, or a separate adjacent vertical coupler can be used for receiving a signal. The received signal then is transmitted back to an optical combiner/splitter (for the single aperture configuration) that directed at least a portion of the received optical signal toward the balanced detectors or directly toward the balanced detectors. The received optical signal is directed to a directional coupler that is also connected on its other input to the input reference signal. The two outputs of the directional coupler are directed, respectively, to one of the two photodetectors of the balanced receiver. The pixel can be coupled to appropriate electrical connections that control the optical switch to turn the pixel on, the optical detectors and optionally the optical monitor.

The receiving function is shown in FIG. 13. The signal reflected from an object is received at a vertical coupler, which can be essentially one of the elements used for vertical transmission but operated in reverse (common aperture) or a separate vertical coupler, which may or may not be adjacent. The modulated input light is used as a reference for a receiver. To extract the information from the returned optical signal, the received optical signal and the reference (input oscillator) signal are directed to opposite arms of a directional coupler that distributes power between adjacent waveguides each carrying the respective optical signals to the directional coupler. The adjacent waveguides are arranged adjacent to each other, and can have a length selected to split the power roughly equally between the two output lines of the directional coupler. Each output then is directed to a separate optical detector, such as a photomultiplier, a photodiode or other light receiving component, that form a coherent balanced receiver.

A balanced receiver incorporated into the pixel allows each pixel to act as a coherent receiver as well as a directional transmitter, although the receiver elements can be separate from the steering transmitter array. The coherent receiver receives optical signals from the convolution of a reference signal associated with the local oscillator (i.e., the laser source) and the return signal. In embodiments, as shown in FIG. 13A, a balanced receiver 1300 comprises a pair of detectors 1301, 1303. Input signal 1305 is routed from row waveguide 1307 to pixel waveguide 1308 by low loss ring switch 1311. Vertical deflector 1319 is coupled to extended waveguide 1304 which is optically connected to detection waveguide 1306. The signals in pixel waveguide 1308 and detection waveguide 1306 mix at directional coupler 1309. Directional coupler 1309 provides for power exchanging between the two closely passing waveguides while establishing a beat frequency between the two signals that then provides for extraction of signal information upon the separation of the waveguides for separate detection at detectors 1301 and 1303.

As shown in FIG. 13B, the optical portions of a pixel are shown providing transmission and receiving functions. Input signal 1313 is directed along row waveguide 1305. If ring switch 1311 is turned on, the optical signal is diverted to pixel waveguide 1308, while if ring switch 1311 is off, the input signal continues down the row waveguide 1305. A portion of the input signal 1313 is split and directed to directional coupler 1309 as a local oscillator 1315 into reference waveguide 1320 by way of splitter 1312. Splitter 1312 can function as a tap with a fraction of the optical intensity, e.g., 10%, directed along reference waveguide 1314 while a majority of the optical intensity is directed to vertical deflector 1319, although generally the optical intensity directed along reference waveguide can be from about 1% to about 50%. The other portion of the input signal 1313 is sent as a transmit signal 1317 along input/output waveguide 1314 to the vertical deflector 1319 where it exits the pixel. Vertical deflector 1319 also functions as a receiver and directs the received optical signal along input/output waveguide 1314, which is depicted for convenience as two lines in the figure, although it is a single structure. Splitter/coupler 1316 couples pixel waveguide 1308 and detector waveguide 1318 with input/output waveguide 1314. Reference waveguide 1320 and detector waveguide 1318 are routed through a directional coupler 1309 and then split for directing to a balanced receiver 1310. Balanced receiver 1310 includes a first photodetector 1325 and a second photodetector 1327. The local oscillator 1315 and return signal 1321 are mixed at the directional coupler and the resulting beat signals are detected at the balanced receiver. In embodiments, balanced receiver may be paired with a trans impedance amplifier circuit to amplify the signal. In embodiments, resistors may be added to the photodiode electrical connections to enable monitoring switch status.

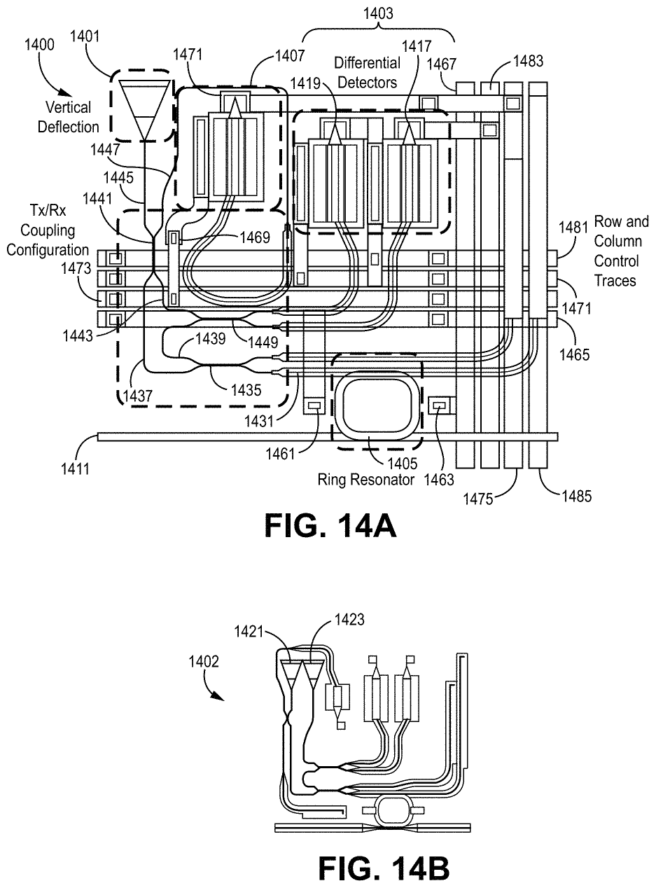

Referring to FIG. 14A, an exemplary layout of a pixel is shown illustrating the pixel components, optical pathways, and electrical pathways. Pixel 1400 comprises a vertical deflector 1401, a balanced receiver 1403, and a low loss switch 1405. In embodiments, pixel 1400 may comprise a monitoring photoreceiver 1407, such as a photodiode. Low loss switch 1405, vertical deflector 1401, balanced receiver 1403, and optional monitoring photodiode 1407 are optically connected with a network of optical waveguides with appropriate splitters/couplers. Row waveguide 1411 provides an optical pathway from a laser input source to pixel 1400 through low loss switch 1405, and generally row waveguide 1411 connects an array of pixels along its path, in which earlier pixels on the path can divert the optical input and downstream pixels can receive the input optical signal if low loss switch 1405 is off. The pixel network of optical waveguides comprises pixel waveguide 1431 that couples with low loss switch 1405 that is subsequently connected to splitter/tap 1435 that splits the signal into transmission waveguide 1437 and reference waveguide 1439. Transmission waveguide 1417 continues to an input/output splitter/tap/combiner 1441, where it is combined on a first side of the structure with a detector waveguide 1443. On the second side of input/output splitter/tap/combiner 1441, it connects with input/output waveguide 1445 and monitor waveguide 1447. Reference waveguide 1439 and detector waveguide 1443 from directional coupler 1449 where the received optical signal and the reference optical signal are mixed to form a beat signal with shared power that are then directed to balanced receiver 1403 that comprises first photodetector 1417 and second photodetector 1419.

Pixel 1400 comprises electrical contacts for connection with an overlaid optical circuit, such as provided by a circuit board, and FIG. 14A shows respective electrical circuits and contact points with the optical chip. Specifically, electrical pathways to the pixel and interconnect with a set of four column electrical lines and a set of four row electrical lines 1415. Electrical lines may transmit, for example, a positive voltage or a negative voltage, or an electrical line may be a neutral or a ground, as appropriate to provide desired connections. The electrical circuits are shown as provided by rows and columns of conductive electrical lines that allow for completing appropriate circuits through components on the optical chip. Electrical contacts 1461, 1463 provide current for operating low loss switch 1405, in which electrical contact 1461 connects with row line 1465 and electrical contact 1463 connects with column line 1467. Electrical contacts 1469, 1471 provide electrical connections to monitor photodiode 1407, in which elecrtrical contact 1469 connects with row line 1473 and electrical contact 1471 connects with column line 1475. Row lines 1479, 1481 connect with contacts associated with photodetectors 1419 and 1430, and column lines 1483, 1485 connect with contacts associated with photodetectors 1419, 1430.

FIG. 14B depicts an alternative embodiment of pixel 1402 having a first vertical emitter 1421 and a second vertical emitter 1423. In embodiments, first vertical emitter 1421 is used only for emitting optical signals and second vertical emitter 1423 is used only for receiving optical transmissions. This can be referred to as a dual aperture structure, while the structure in FIG. 14A can be referred to as a single aperture structure to distinguish them.

The pixel dimensions generally dictate the overall chip size, which will impact the fabrication yield as well as the size and optical performance which may influence an interface with free space coupling optics. Larger pixels can involve longer propagation distances which reduce output power, range and sensitivity. Reductions in area and can be realized through careful component optimization.

In a FMCW system, laser frequency can be linearly chirped in frequency with a maximum chirp bandwidth B and laser output sent to the target (Tx signal). Reflected light from the target is mixed with the copy of the Tx signal (local oscillator) in a balanced detector pair. This down converts the beat signal. Frequency of the beat signal represents the target distance and its radial velocity. Radial velocity and distance can be calculated when laser frequency is modulated with a triangular waveform. The modulation of the laser frequency can be according to a triangular wave form, as shown in FIG. 1B, with the period referred to as the chirp time (T) and the frequency variation over the modulation being the chirp bandwidth (B). While the directional coupler splits the power between the two waveguides, the two signals establish a beat between the two signals.

The up beat frequency and the down beat frequency give the distance and radial velocity Mixing the laser output (local oscillator) with the time delayed optical field reflected from the target generates a time varying intermediate frequency (IF) as shown in FIG. 1B. IF frequency is a function of range, frequency modulation (chirp) bandwidth (B) and modulation (chirp) period (T), as indicated in Eq. (1), where c is the speed of light.

Range=((fdiff_down+fdiff_up)/2)·(T·c)/(4·B). (1)

The two intermediate frequencies, fdiff_down and fdiff_up) are obtained from the Fourier transform of the signals received by the two receivers and selecting the center frequencies corresponding to the peak of the power spectrum in the Fourier transform. For the case of a moving target, a Doppler frequency shift will be superimposed to IF (shown as change in frequency over the waveform ramp-up and decrease during ramp-down, see FIG. 1B. Note that the Doppler shift is function of target radial velocity and trajectory. The Doppler (radial) velocity can be obtained from the following equation.

Doppler Velocity (V_{D})=((fdiff_down−fdiff_up)/2)·λ/2), (2)

f_{IF}=(f⁺_{IF}+f⁻_{IF})/2=((fdiff_down+fdiff_up)/2). (3)

where λ is the laser wavelength. The object velocity (V) is evaluated as V_{D}/Cos(ψ₂), where ψ₂ is the angle between the laser beam direction for an edge of the object and the direction of motion, which is described further below. The beat frequencies can be extracted from Fourier transforms of the sum of the current as a function of time from the balanced detectors using known techniques from coherent detection.

The range and radial velocity information can then be used to populate the voxels. The distance is determined within a particular resolution. Resolution (ΔR): Describes the minimum distance between two resolvable semi-transparent surfaces.—Semi-transparent surfaces closer than minimum distance will show up as a single surface. Resolution is inversely proportional to tuning bandwidth ΔR=0.89 c/B. The distance determination is also evaluated within a particular precision or numerical error. Precision (σR): Describes the measurement accuracy and depends on received signal SNR and chirp bandwidth. In most systems, Precision (σR)>>Resolution (ΔR) and is determined by σR=c/(4πB)(3/SNR)^{1/2}, where SNR is the signal to noise ratio.

In FMCW system design, laser chip bandwidth can be selected to meet the system precision requirements. Generally, a SNR of at least about 13 dB is used, which translates to σR=0.93 cm precision for B=1 GHz. For higher precision, laser chirp bandwidth can be increased. This precision value represents the worst case value at the lowest value of SNR, for closer targets or targets with higher reflectivity, the receive signal SNR increases, and thus the precision improves. For example, for the same chirp bandwidth of 1 GHz, if SNR increases from 13 dB to 30 dB, precision increases from σR=0.93 cm to σR=0.13 cm. Note if higher precision is desired then, chirp bandwidth can be increased.

### Improved Image Segmentation Using 4D Lidar Output

In dynamic environments, image pixels that belong to a moving object a have similar Doppler (radial) velocity regardless of the imaging perspective, although the value of the Doppler (radial) velocity is a function of the angle, as explained below. Thus, use of Doppler (radial) velocity for clustering voxels addition to their spatial proximity in a 3D point cloud image enables improved segmentation of the image and more accurately define object boundary. Based on this principle, with populated voxels, objects can be identified. In particular, neighboring points in the angular distribution at approximately the same range and traveling at the same speed can be grouped as part of the same object. Correspondingly, identification of the object provides for backing out the trajectory from the Doppler velocities. The process can be organized into the following algorithm.

### Algorithm

1. Identify the number of Velocity Bins (Vi) in Image frame:
a. Use Vi+/−ΔV for each cluster, where ΔV is variation of radial velocity in each cluster
2. For each (radial) Velocity Bin Vi
a. Using spatial clustering techniques such as GNM (Gaussian Noise Model), K-NN (K-Nearest Neighbor) or CNN (Convolutional Neural Networks), define object boundaries. This operation is used to segment objects with similar doppler (radial) velocity in adjacent spatial positions.
Above algorithm can be used to quick identification of dynamic objects in a single frame without use of information from other image frames.
Estimation of Object Trajectory and Speed from a Single Lidar Frame with 4D Data

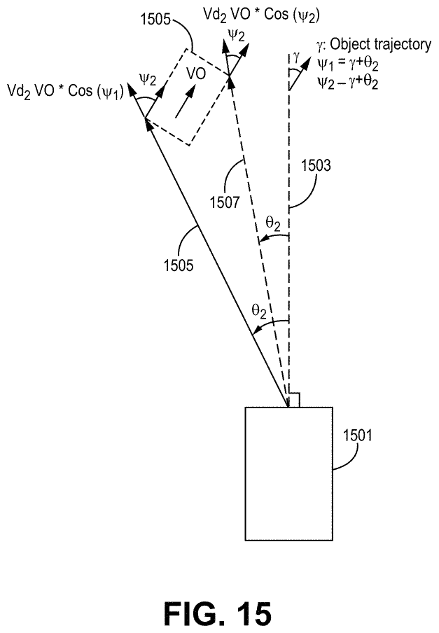

In coherent Lidar, Doppler shift is related to radial velocity of the point being measured and trajectory This is schematically laid out in FIG. 15 in two dimensions, which outlines the evaluation of the radial velocity from the Doppler radial velocity and image of the object boundaries. The object trajectory in 2D is estimated from a single frame 4D image, grouping of the Voxels, as described above, and using two edge points of the image:

$$\begin{matrix}γ = {tan}^{- 1} ( \frac{{Vd}_{1} \cdot cos ( {θ}_{2} ) - {Vd}_{2} \cdot cos ( {θ}_{1} )}{{Vd}_{1} \cdot sin ( {θ}_{2} ) - {Vd}_{2} \cdot sin ( {θ}_{1} )} ) & Eq : 4 \\ where & \\ {V}_{0} = \frac{{Vd}_{1}}{cos ( {θ}_{1} + γ )} & Eq . 5\end{matrix}$$

The angles γ, θ₁, θ₂, ψ₁, ψ₂ are shown in Fig. A, and ψ₁=γ+θ₁, and ψ₂=γ+θ₂. Also, Vd₁=V₀+cos(ψ₁) and Vd₂=V₀+cos(ψ₂). Unknowns V₀ and γ can be evaluated from known Vd₁, Vd₂, θ₁, and θ₂. This can be generalized to three dimensions using a third point of the three dimensional position image and the radial velocity of the third point.

Referring to FIG. 15, LIDAR 1501 forms an image in its field of view in which the normal line 1503 is the center of its field of view. Object 1505 is imaged with LIDAR 1501, and its image is used to populate voxels. Based on Doppler velocities and positions, two edges are identified that are marked with rays 1505, 1507, that form, respectively, angles θ₁, θ₂ relative to the normal line 1503.

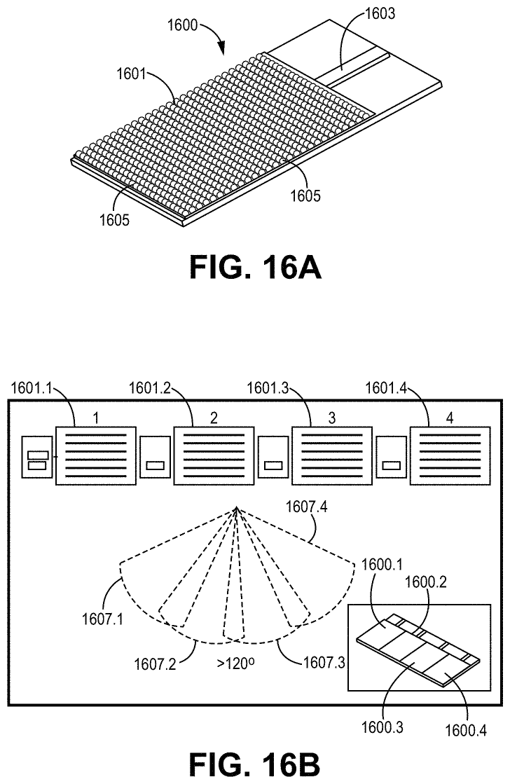

Referring to FIG. 16A, an image sensor 1600 may have a vertical switch array 1601 coupled with a laser chip 1603. In embodiments, vertical switch array 1601 may be a N×M array of pixels 1605 with, for example, a 40 degree field of view along the horizon and, for example, a 30 degree field of view vertically. Multiple image sensors 1601 may be grouped together to create a larger effective vertical switch array with an increased field of view. As shown in FIG. 16B, four image sensors 1600.1, 1600.2, 1600.3, 1600.4 are positioned alongside one another creating a N×4M array of pixels 1605. Each image sensor 1600.1, 1600.2, 1600.3, 1600.4 has a 40 degree field of view 1607.1, 1607.2, 1607.3, 1607.4. However, the field of views 1607.1, 1607.2, 1607.3, 1607.4 partially overlap, creating a field of view that is greater than 120 degrees but less than 160 degrees. The field of view may be further increased or decreased by pairing more image or fewer image sensors. As described above, it may be possible to simultaneously scan the arrays separately if they operate on different frequencies of if the respective receivers have adequately low cross talk.

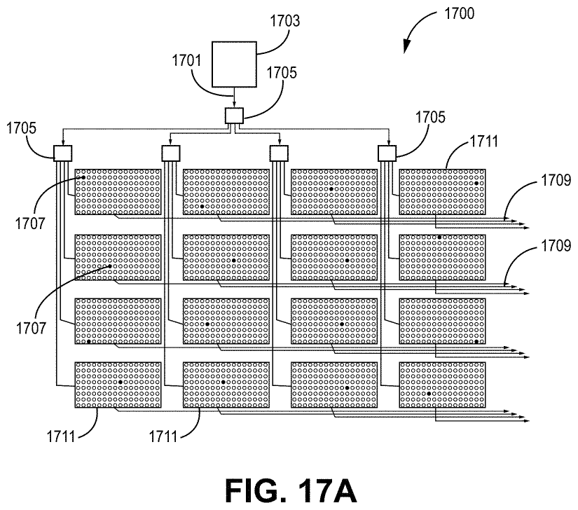

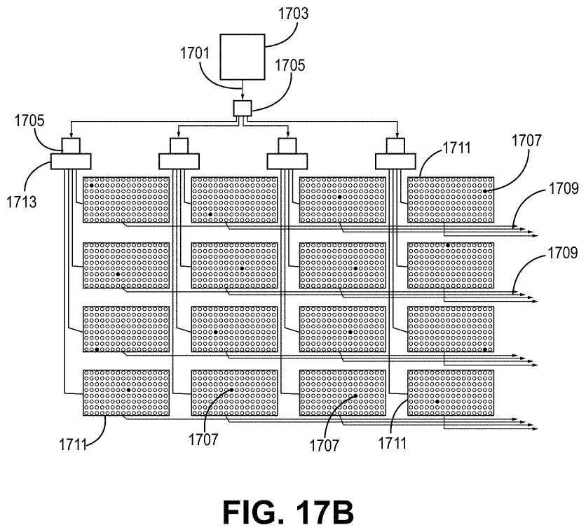

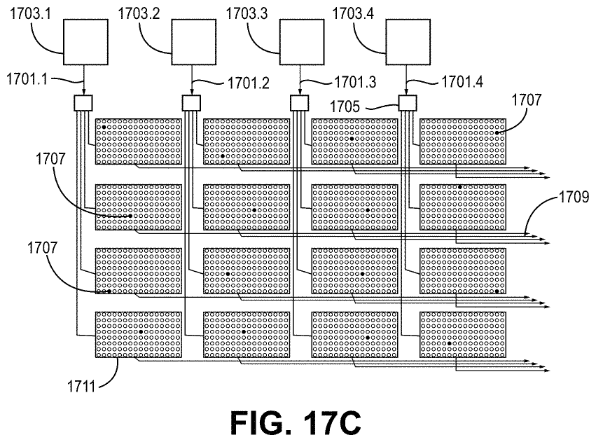

The vertical array switching devices described herein generally rely on scanning each pixel by turning on or off a low loss switch within the pixel. In the simplest configuration of an N×M pixel array, frame rate scales with the total number of pixels in the array. Sequential scanning of each pixel in a large array reduces the frame rate. FIGS. 17A-17C show methods of increasing frame rate without reducing the total pixel number if arrays of vertical scanning arrays can be formed with sufficiently low cross talk between them that the separate arrays can be scanned at the same or overlapping times. Referring to FIG. 17A, an image sensor 1700 may include multiple optical chips with a vertical switch array 1711 with an array of transmission pixels 1707. An optical signal 1701 produced by laser 1703 is split into 16 by passing through a first 4-way splitter 1705, and those 4 optical signals each pass through an additional 4-way splitter 1705. Thus, a single laser source 1703 provides optical signals for 16 vertical switch arrays 1711 to have 16 transmitting pixels 1707 at the same time. Each transmitting pixel 1707 provides an output signal 1709, enabling reading 16 pixel outputs 1713 at the same time, thereby increasing the frame rate sixteen fold. However, since laser light is shared among 16 sub-arrays 1711, transmitted light from the pixel 1707 is reduced by approximately 12 dB, thus reducing the measurement range by about 4 times. This architecture may be preferable, for example, for short range, high frame rate applications. In order to improve the range while keeping the 16× higher frame rate, one approach is to further increase the laser power, such as by including amplifiers 1713 after the splitters to boost the signal, as shown in FIG. 17B.

An alternative embodiment, as shown in FIG. 17C, uses multiple high-power lasers to increase the laser power shared by each of 16 pixels for longer range applications. For example, four lasers 1703.1, 1703.2, 1703.3, 1703.4 could be used, where each laser is split only 4 ways, thereby increasing the power to each pixel fourfold. Increased power consumption and assembly complexity may provide some limits to the number of lasers that can be incorporated into a multiple array system for mobile applications.

By way of example, in order to support a 600×400 pixel array, 16 vertical switch arrays can be used. In a configuration where the laser output is then split 16 ways to power each of the vertical switch arrays, the combined 600×400 pixel resolution can scan at a rate of 20 frames/sec. Following these examples, it is clear how to adjust the array size to achieve the frame rate of an image sensor.

### Operation

With a single vertical coupling array, it is only possible to turn on a single transmitting pixel in a row at a time for each laser frequency to allow for measurement of the reflected signal. If a vertical coupling array is connected to polychromatic light, either multiplexed or not, the different laser frequencies can be scanned separately for transmission and reception. Alternatively, if different laser light sources are configured to send optical signals down different rows of sets of rows, these can be separately scanned if there is sufficiently low crosstalk between the signals. The scanning of the pixels may not proceed linearly along a grid, and based on switching times (on and off), less noise, lower cross talk and shorter scan times may, in some embodiments, occur if sequential on pixels may be spatially separated. On the other hand, for focused scanning a region of interest, sufficient scanning efficiencies are gained from the limited focused scans that sequential scans in adjacent pixels can be very efficient even if per scan rates may be slowed somewhat.

The Lidar systems described herein provide considerable flexibility and efficiencies that allow for adaptation or selection of alternative operation cycles depending on the observed circumstances. Parameters that can influence selection of scanning protocols can include: distance of objects, speed of object motion, signal to noise of reflected signal, and the like. While signal to noise ration depends on object distance and transmitted laser power, as described above, it can also depend on reflectivity of the object and weather conditions, for example, rain or snow can scatter significant amounts of outgoing and reflected light. The ability to have a wide range of adjustability with virtual instantaneous programing ability is a great advantage.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein. To the extent that specific structures, compositions and/or processes are described herein with components, elements, ingredients or other partitions, it is to be understand that the disclosure herein covers the specific embodiments, embodiments comprising the specific components, elements, ingredients, other partitions or combinations thereof as well as embodiments consisting essentially of such specific components, ingredients or other partitions or combinations thereof that can include additional features that do not change the fundamental nature of the subject matter, as suggested in the discussion, unless otherwise specifically indicated. The use of the term “about” herein refers to imprecision due to the measurement for the particular parameter as would be understood by a person f ordinary skill in the art, unless explicitly indicated otherwise.

What is claimed is:

1. An optical chip comprising:
a row of selectable emitting elements comprising: a row feed optical waveguide, a plurality of selectable, electrically actuated solid state optical switches, a pixel optical waveguide associated with each optical switch configured to receive the switched optical signal, and a solid state first vertical coupler associated with the pixel waveguide configured to direct the optical signal out of the plane of the optical chip.

2. The optical chip of claim 1 further comprising one or more additional plurality of rows of selectable emitting elements each comprising a row feed optical waveguide, plurality of selectable, electrically actuated-solid state optical switches is associated with the row feed optical waveguide, a pixel optical waveguide associated with each optical switch configured to receive the switched optical signal, and a solid state vertical turning mirror associated with the target waveguide configured to direct the optical signal out of the plane of the optical chip.

3. The optical chip of claim 2 further comprising a feed optical waveguide, a plurality of row switches to direct an optical signal along a row feed optical waveguide.

4. The optical chip of claim 2 further comprising multiple ports wherein each port is configured to provide input into a row.

5. The optical chip of claim 1 wherein each pixel further comprises a balanced detector that is configured to receive light from the first vertical coupler, or wherein each pixel further comprises a solid state second vertical coupler and a balanced detector that is configured to receive light from the second vertical coupler.

6. The optical chip of claim 5 wherein each pixel comprises an optical tap connected to the pixel optical waveguide and to a directional coupler, wherein the directional coupler is further connected to a receiver waveguide optically coupled to an optical splitter/coupler optically coupled to the first vertical coupler or optically coupler to the second vertical coupler, wherein the balanced detector comprises two optical detectors respectively optically connected to two output waveguides from the directional coupler.

7. The optical chip of claim 1 further comprising a balanced detector and a directional coupler that is configured to receive light from a second vertical coupler and from the row input waveguide, wherein the balanced detector comprises two photodetectors configured to receive output from respective arms of the directional coupler and wherein the balanced detector is within a receiver pixel separate from a selectable optical pixel.

8. The optical chip of claim 1 wherein the selectable optical pixel further comprises an optical tap connected to the pixel waveguide, and a monitoring photodetector configured to receive light from the optical tap.

9. The optical chip of claim 1 wherein the selectable optical switch comprises a ring coupler with thermo-optical heaters.

10. The optical chip of claim 1 wherein the first vertical coupler comprises a vertical coupler array.

11. The optical chip of claim 1 wherein the first vertical coupler comprises a groove with a turning mirror.

12. The optical chip of claim 1 wherein the optical chip has silicon photonic optical structures formed with silicon on insulator format.

13. The optical chip of claim 1 wherein the optical chip has planar lightwave circuit structures comprising SiOₓN_{y}, 0≤x≤2, 0≤y≤4/3.

14. A optical imaging device comprising: an optical chip of claim 2 and a lens wherein the position of the lens determines an angle of transmission of light from a selectable emitting element.

15. The optical imaging device of claim 14 wherein the lens covers all of the pixels, is approximately spaced a focal length away from the optical chip light emitting surface, and directs light from the selectable emitting elements at respective angles in a field of view.

16. The optical imaging device of claim 15 wherein the lens comprises a microlenses associated with one selectable emitting element, and further comprising additional microlenses each associated with a separate selectable emitting element.

17. The optical imaging device of claim 14 further comprising an electrical circuit board electrically connected to the optical chip, wherein the electrical circuit board comprises electrical switches configured to selectively turn on the selectable optical switches.

18. The optical imaging device of claim 17 wherein a controller is connected to operate the electrical circuit board, wherein the controller comprises a processor and a power supply.

19. The optical imaging device of claim 17 wherein each pixel comprises an optical tap connected to the pixel optical waveguide and to a direction coupler, wherein the directional coupler is further connected to a receiver waveguide optically coupled to an optical splitter/coupler optically coupled to the first vertical coupler or optically coupler to the second vertical coupler, wherein the balanced detector comprises two optical detectors respectively optically connected to two output waveguides from the directional coupler, and wherein the balanced detector is electrically connected to the electrical circuit board.

20. The optical imaging device of claim 14 further comprising an optical detector adjacent the optical chip, the optical detector comprising a directional coupler optically connected to a vertical coupler configured to receive reflected light from the optical chip and to a optical source from a local oscillator, and a balanced detector comprising two photodetectors respectively coupled to an output branch of the directional coupler.

21. An optical array for transmitting a panorama of optical continuous wave transmissions comprising:
a two dimensional array of selectable optical pixels;
one or more continuous wave lasers providing input into the two dimensional array; and
a lens system comprising either a single lens with a size to cover the two dimensional array of selectable optical pixels or an array of lenses aligned with the selectable optical pixels, wherein the lens or lenses are configured to direct the optical transmission from the selectable optical pixels along an angle different from the angle of the other pixels such that collectively the array of pixels covers a selected solid angle of the field of view.

22. The optical array of claim 21 wherein the two dimensional array is at least 3 pixels by three pixels, and wherein the two-dimensional array of optical pixels is on a single optical chip.

23. The optical array of claim 22 further comprising at least one additional two-dimensional array of optical pixels arranged on a separate optical chip and configured with a lens system such that each optical chip covers a portion of the field of view.

24. The optical array of claim 21 wherein each selectable optical pixel comprises an optical switch with an electrical connection such that an electrical circuit selects the pixel through a change in the power state delivered by the electrical connection to the pixel.

25. The optical array of claim 24 wherein the optical switch comprises a ring resonator with a thermo-optic component or electro-optic component connected to the electrical connection and wherein the selectable optical pixel comprises a first vertical coupler that is a V-groove reflector or a grating coupler.

26. The optical array of claim 25 wherein the selectable optical pixel further comprises an optical tap connected to the pixel waveguide, and a monitoring photodetector configured to receive light from the optical tap.

27. The optical array of claim 25 wherein the selectable optical pixel further comprises a balanced detector and a directional coupler that is configured to receive light either from the first vertical coupler or from a second vertical coupler, and to receive portion of light from the row input waveguide, wherein the balanced detector comprises two photodetectors configured to receive output from respective arms of the directional coupler

28. A rapid optical imager comprising a plurality of optical arrays of claim 19, wherein the plurality of optical arrays are oriented to image the same field of view at staggered times to increase overall frame speed.

29. The rapid optical imager of claim 28 wherein the plurality of optical arrays is from 4 to 16 optical arrays, wherein the plurality of optical arrays are optically connected to 1 to 16 lasers, and wherein the plurality of optical arrays are electrically connected to a controller that selects pixels for transmission.

30. A high resolution optical imager comprising a plurality of optical arrays of claim 21, wherein the plurality of optical arrays are oriented to image staggered overlapping portions of a selected field of view, and a controller electrically connected to the plurality of optical arrays, wherein the controller selects pixels for transmission and assembles a full image based on received images from the plurality of optical arrays.

31. A an optical chip comprising a light emitting pixel comprising:
an input waveguide;
a pixel waveguide;
an actuatable solid state optical switch with an electrical tuning element providing for switching selected optical signal from the input waveguide into the pixel waveguide;
a first splitter optically connected to the pixel waveguide;
a solid state vertical coupler configured to receive output from one branch of the splitter; and
a lens configured to direct light output form the vertical coupler at a particular angle relative to a plane of the optical chip.

32. The optical chip of claim 31 further comprising a first optical detector configured to receive output from another branch of the splitter, wherein the first splitter is a tap and wherein the first optical detector monitors the presence of an optical signal directed to the turning mirror.

33. The optical chip of claim 32 further comprising a second splitter configured between the first splitter and the turning mirror, a differential coupler configured to combine optical signals to obtain a beat signal from the first splitter and a received optical signal from the second splitter; and a balanced detector comprising a first photodetector and a second photodetector, wherein the first photodetector and the second photodetector receive optical signals from alternative branches of the differential coupler.

34. A method for real time image scanning over a field of view without mechanical motion, the method comprising:
scanning with coherent frequency modulated continuous wave laser light using a plurality of pixels in an array turned on at selected times to provide a measurement at one grid point in the image wherein the reflected light is sampled approximately independent of reflected light from other grid in the image points; and
populating voxels of a virtual four dimensional image with information on position and radial velocity of objects in the image.

35. The method of claim 34 wherein the pixels comprise optical switches that can be selectively turned on to project light along an angle specific for that switch.

36. The method of claim 35 wherein detection of reflected light is performed using a balanced detector in the pixel, or using a balanced detector associated with a row of selectable pixels, or a detector adjacent the array of pixels.

37. The method of claim 35 wherein a plurality of arrays of pixels are arranged to scan overlapping spaced apart portions of the field of view.

38. The method of claim 35 wherein a plurality of arrays to scan of pixels are oriented to scan the same field of view to increase frame rate.

39. The method of claim 34 wherein the scanning is performed with one laser wavelength.

40. The method of claim 34 wherein the scanning is performed with a plurality of laser wavelengths.

41. The method of claim 34 wherein Doppler shifts are used to determine relative velocity at each point in the image, wherein relative velocities and positions are used to group voxels associated with an object, and where the grouped voxels are used to determine the object velocity.

42. A method for tracking image evolution in a field of view using a coherent optical transmitter/receiver, the method comprising:
measuring the four dimensional (position plus radial velocity) along a field of view using a coherent continuous wave laser optical array;
determining a portion of the field of view as a region of interest based on identification of a moving object;
providing follow up measurements directed to the region of interest by addressing the optical array at pixels directed to the region of interest; and
obtaining time evolution of the image based on the follow up measurements.

43. The method of claim 42 wherein the optical array comprises pixels with selectable optical switches to turn on a pixel for emitting light along an angle in the field of view specific for the pixel.

44. The method of claim 43 wherein detection of reflected light is performed using a balanced detector in the pixel, or using a balanced detector associated with a row of selectable pixels, or a detector adjacent the array of pixels.

45. The method of claim 43 wherein a plurality of arrays of pixels are arranged to scan overlapping spaced apart portions of the field of view and/or are oriented to scan the same field of view to increase frame rate.

46. The method of claim 43 wherein providing follow up measurements is performed by performing a scan using pixels with angular emissions for the pixels cover the regions of interest in the field of view.

47. The method of claim 46 further comprising performing additional scans of the full field of view interspersed with providing follow up measurements.
